(19) United States
(12) Patent Application Publication
(10) Pub. No.: US 2016/0205693 A1
(43) Pub. Date: Jul. 14, 2016

(54) SERVICE ACCESS METHOD, USER EQUIPMENT, AND RADIO CONTROLLER

(71) Applicant: Huawei Technologies Co., Ltd., Shenzhen (CN)

(72) Inventors: Yao LU, Shenzhen (CN); You LI, Shenzhen (CN); Yong XIE, Shenzhen (CN)

(21) Appl. No.: 15/080,235

(22) Filed: Mar. 24, 2016

Related U.S. Application Data
(63) Continuation of application No. PCT/CN2014/086630, filed on Sep. 16, 2014.

(30) Foreign Application Priority Data
Sep. 26, 2013 (CN) 201310444534.9

(51) Int. Cl. H04W 72/04; H04J 11/00; H04W 48/04; H04W 28/02; H04W 8/08

(52) U.S. Cl. CPC H04W 72/0493; H04W 28/0236; H04W 8/082; H04W 28/0215; H04W 48/04; H04J 11/00; H04W 88/02

(57) ABSTRACT

A service access method includes: receiving a service request from a UE; determining a candidate base station set of the UE according to the service request, the candidate base station set including at least one candidate base station, and a base station standard of any candidate base station in the candidate base station set including a base station standard supported by the UE; determining a serving base station according to a pre-determined rule, the serving base station being one of the at least one candidate base station; sending, to the UE, a service acceptance message requested by the service request, the service acceptance message carrying information about the serving base station.

### CROSS-REFERENCE TO RELATED APPLICATIONS

This application is a continuation of International Patent Application No. PCT/CN2014/086630, filed on Sep. 16, 2014, which claims the priority to Chinese Patent Application No. 201310444534.9 filed on Sep. 26, 2013, both of which are hereby incorporated by reference in their entireties.

### FIELD

The present invention relates to the communication field, and specifically to a service access method, a user equipment and a wireless controller.

### BACKGROUND

In the current long term evolution (LTE) system network, for an end-to-end quality of service (QoS) policy, a user equipment (UE) initiates a service request via a base station (evolutional Node B, eNB or e-NodeB), a policy and charging rules function (PCRF) entity issues a corresponding QoS policy to a packet data network gateway (PGW) based on a service type, and each node maps the QoS policy to a corresponding bearer, to establish a user plane path for the UE.

Conventionally, for a request of a UE for establishing a user plane bearer, the bearer can only be established based on a QoS policy determined by the PCRF, and there is no opportunity to choose a better path, and thus flexibly choosing an access base station (or an access path) for the UE can not be achieved.

### SUMMARY

A service access method, a user equipment and a wireless controller are provided according to embodiments of the invention, by which a high-quality service access path can be established for a UE.

In a first aspect, a service access method is provided. The method includes: receiving a service request of a user equipment (UE); determining a set of candidate base stations of the UE according to the service request, where the set of candidate base stations includes at least one candidate base station, and a base station standard of any candidate base station in the set of candidate base stations includes a base station standard supported by the UE; determining a serving base station based on a predetermined rule, where the serving base station is one of the at least one candidate base station; and sending a service acceptance message for the service request to the UE, where the service acceptance message carries information about the serving base station.

Optionally, the service request carries a service type of the UE, and determining the serving base station based on the predetermined rule includes: determining the serving base station based on at least one of following information: a quality of service (QoS) policy corresponding to the service type, channel quality information of the at least one candidate base station, resource usage information of the at least one candidate base station, link information of at least one transport network connected to the at least one candidate base station and a traffic control policy corresponding to the service type in the at least one transport network.

Optionally, before determining the serving base station based on the predetermined rule, the method further includes: obtaining at least one of following information: the quality of service (QoS) policy corresponding to the service type, the channel quality information of the at least one candidate base station, the resource usage information of the at least one candidate base station, the link information of the at least one transport network connected to the at least one candidate base station and the traffic control policy corresponding to the service type in the at least one transport network.

Optionally, the service request carries the base station standard supported by the UE and location information of the UE, and determining the set of candidate base stations of the UE according to the service request includes determining the set of candidate base stations based on the base station standard supported by the UE and the location information of the UE, where a distance between a location of the UE and a location of any candidate base station in the set of candidate base stations is smaller than a predetermined distance.

Optionally, the service request carries an ID of the UE, and determining the set of candidate base stations of the UE according to the service request includes: obtaining the base station standard supported by the UE and location information of the UE based on the ID of the UE; and determining the set of candidate base stations based on the base station standard supported by the UE and the location information of the UE, where a distance between a location of the UE and a location of any candidate base station in set of the candidate base stations is smaller than a predetermined distance.

Optionally, the service request carries a base station identity (ID), a public land mobile network (PLMN), carrier information and a base station standard of at least one base station, where the base station standard of the at least one base station includes the base station standard supported by the UE, and determining the set of candidate base stations of the UE according to the service request includes determining the at least one base station to be a candidate base station in the set of candidate base stations according to the service request.

Optionally, obtaining the channel quality information of the at least one candidate base station includes: sending information about the at least one candidate base station to the UE, where the information about the at least one candidate base station includes a base station identity (ID), a public land mobile network (PLMN), carrier information and a base station standard of the at least one candidate base station; and receiving the channel quality information of the at least one candidate base station measured by the UE.

Optionally, the service request further carries channel quality information of the at least one base station, and obtaining the channel quality information of the at least one candidate base station includes obtaining the channel quality information of the at least one candidate base station from the service request.

Optionally, obtaining the QoS policy corresponding to the service type of the UE includes: sending a QoS policy query request to a policy and charging rules function (PCRF) entity of the UE, where the QoS policy query request is configured to request querying for the QoS policy of the UE in the PCRF, and the QoS policy query request carries the service type of the UE; and receiving information about the QoS policy corresponding to the service type of the UE sent by the PCRF.

Optionally, obtaining the resource usage information of the at least one candidate base station includes: sending a resource block (RB) query message to a candidate base station of the at least one candidate base station, where the RB query message is configured to query for RB usage information of the candidate base station of the at least one candidate base station, and the RB usage information of the candidate base station is one of the resource usage information of the candidate base station; and receiving the RB usage information sent by the candidate base station of the at least one candidate base station.

Optionally, obtaining the resource usage information of the at least one candidate base station includes: sending a backhaul resource query message to a transport network controller of at least one transport network connected to the at least one candidate base station, where the backhaul resource query message is configured to query for backhaul resource usage information of the at least one candidate base station, and the backhaul usage information of the candidate base station is one of the resource usage information of the candidate base station; and receiving the backhaul resource usage information of the at least one candidate base station sent by the transport network controller.

Optionally, obtaining the resource usage information of the at least one candidate base station includes: sending a backhaul resource query message to at least one packet data gateway (PGW) connected to the at least one candidate base station, where the backhaul resource query message is configured to query for backhaul resource usage information of the at least one candidate base station, and the backhaul usage information of the candidate base station is one of the resource usage information of the candidate base station; and receiving the backhaul resource usage information of the at least one candidate base station sent by the at least one PGW.

Optionally, obtaining the link information of the at least one transport network connected to the at least one candidate base station includes: sending a link query message to a transport network controller of the at least one transport network connected to the at least one candidate base station, where the link query message is configured to query for the link information of the at least one transport network connected to the at least one candidate base station; and receiving the link information of the at least one transport network connected to the at least one candidate base station sent by the transport network controller, where the link information includes a transport network route delay and/or egress bandwidth usage information of the at least one transport network.

Optionally, obtaining the link information of the at least one transport network connected to the at least one candidate base station includes: sending a route delay query message to a transport network border router of the at least one transport network connected to the at least one candidate base station, where the route delay query message is configured to query for a transport network route delay of the at least one transport network; and receiving the transport network route delay of the at least one transport network sent by the transport network border router.

Optionally, obtaining the link information of the at least one transport network connected to the at least one candidate base station includes: sending an egress bandwidth query message to a transport network traffic controller of the at least one transport network connected to the at least one candidate base station, where the egress bandwidth query message is configured to query for egress bandwidth usage information of the at least one transport network; and receiving the egress bandwidth usage information of the at least one transport network sent by the transport network traffic controller.

Optionally, obtaining the traffic control policy corresponding to the service type in the at least one transport network includes: sending a traffic control policy query message to a transport network controller of the at least one transport network connected to the at least one candidate base station, where the traffic control policy query message is configured to query for the traffic control policy of the at least one transport network; and receiving the traffic control policy of the at least one transport network sent by the transport network controller.

Optionally, obtaining the traffic control policy corresponding to the service type in the at least one transport network includes: sending a traffic control policy query message to a transport network traffic controller of the at least one transport network connected to the at least one candidate base station, where the traffic control policy query message is configured to query for the traffic control policy of the at least one transport network; and receiving the traffic control policy of the at least one transport network sent by the transport network traffic controller.

Optionally, the information about the serving base station includes: an ID, a base station standard, carrier information and PLMN information of the serving base station.

In a second aspect, a service access method is provided. The method includes: sending, by a user equipment (UE), a service request to a wireless network controller of the UE; and receiving, by the UE, a service acceptance message sent by the wireless controller according to the service request, where the service acceptance message carries information about a serving base station, the serving base station is a candidate base station determined by the wireless controller from a set of candidate base stations of the UE based on a predetermined rule, the set of candidate base stations of the UE includes at least one candidate base station of the UE, and the set of candidate base stations of the UE is determined by the wireless controller according to the service request.

Optionally, the service request carries a service type of the UE; and determining, by the wireless controller, the serving base station based on the predetermined rule includes determining, by the wireless controller, the serving base station based on at least one of following information: a quality of service (QoS) policy corresponding to the service type, channel quality information of the at least one candidate base station, resource usage information of the at least one candidate base station, link information of at least one transport network connected to the at least one candidate base station and a traffic control policy corresponding to the service type in the at least one transport network.

Optionally, the service request further carries a base station standard supported by the UE and location information of the UE, which are used by the wireless controller to determine the set of candidate base stations of the UE based on the base station standard supported by the UE and the location information of the UE, where a distance between a location of the UE and a location of any candidate base station in the set of candidate base stations of the UE is smaller than a predetermined distance.

Optionally, the service request further carries a base station identity (ID), a public land mobile network (PLMN), carrier information and a base station standard of at least one base station, where the base station standard of the at least one base station includes a base station standard supported by the UE, and the base station identity (ID), the public land mobile network (PLMN), the carrier information and the base station standard of the at least one base station are used by the wireless controller to determine the at least one base station to be a candidate base station in the set of candidate base stations.

Optionally, the service request further carries an identity (ID) of the UE, which is used by the wireless controller to obtain a base station standard supported by the UE and location information of the UE based on the ID of the UE and determine the set of candidate base stations based on the base station standard supported the UE the and the location information of the UE, where a distance between a location of the UE and a location of any candidate base station in the set of candidate base stations is smaller than a predetermined distance.

Optionally, the quality of service (QoS) policy corresponding to the service type includes a QoS policy obtained by the wireless controller from QoS policy information stored in the wireless controller; or the QoS policy corresponding to the service type includes a QoS policy obtained by the wireless controller from a policy and charging rules function PCRF entity of the UE.

Optionally, the channel quality information of the at least one candidate base station includes channel quality information extracted by the wireless controller from information carried in the service request of the UE; or the channel quality information of the at least one candidate base station includes channel quality information obtained by the wireless controller by querying the at least one candidate base station.

Optionally, the resource usage information of the at least one candidate base station includes a resource block (RB) usage message obtained by the wireless controller by querying the at least one candidate base station; or the resource usage information of the at least one candidate base station includes a backhaul resource usage message obtained by the wireless controller by querying a transport network controller connected to the at least one candidate base station; or the resource usage information of the at least one candidate base station includes a backhaul resource usage message obtained by the wireless controller by querying at least one packet data gateway (PGW) connected to the at least one candidate base station.

Optionally, the link information of the at least one transport network connected to the at least one candidate base station includes transport network link information obtained by the wireless controller by querying a transport network controller of the at least one transport network connected to the at least one candidate base station; or the link information of the at least one transport network connected to the at least one candidate base station includes a transport network route delay obtained by the wireless controller by querying a border router of the at least one transport network connected to the at least one candidate base station; or the link information of the at least one transport network connected to the at least one candidate base station includes egress bandwidth usage information obtained by the wireless controller by querying a transport network traffic controller of the at least one transport network connected to the at least one candidate base station.

Optionally, the traffic control policy corresponding to the service type in the at least one transport network includes a traffic control policy obtained by the wireless controller by querying a transport network controller of the at least one transport network connected to the at least one candidate base station; or the traffic control policy corresponding to the service type in the at least one transport network includes a traffic control policy obtained by the wireless controller by querying a transport network traffic controller of the at least one transport network connected to the at least one candidate base station.

In a third aspect, a wireless controller is provided. The wireless controller includes: a receiving unit, configured to receive a service request of a user equipment (UE); a determination unit, configured to determine a set of candidate base stations of the UE according to the service request, where the set of candidate base stations includes at least one candidate base station, and a base station standard of any candidate base station in the set of candidate base stations includes a base station standard supported by the UE, and where the determination unit is further configured to determine a serving base station based on a predetermined rule, where the serving base station is one of the at least one candidate base station; and a sending unit, configured to send a service acceptance message for the service request to the UE, where the service acceptance message carries information about the serving base station.

Optionally, the service request carries a service type of the UE, and the determination unit, for determining the serving base station based on the predetermined rule, is configured to determine the serving base station based on at least one of follows: a quality of service (QoS) policy corresponding to the service type, channel quality information of the at least one candidate base station, resource usage information of the at least one candidate base station, link information of at least one transport network connected to the at least one candidate base station and a traffic control policy corresponding to the service type in the at least one transport network.

Optionally, the wireless controller further includes an obtaining unit configured to obtain at least one of following information: the quality of service (QoS) policy corresponding to the service type, the channel quality information of the at least one candidate base station, the resource usage information of the at least one candidate base station, the link information of at least one transport network connected to the at least one candidate base station and the traffic control policy corresponding to the service type in the at least one transport network.

Optionally, the service request carries a base station standard supported by the UE and location information of the UE, and the determination unit, for determining the set of candidate base stations of the UE according to the service request, is configured to determine the set of candidate base stations based on the base station standard supported by the UE and the location information of the UE, where a distance between a location of the UE and a location of any candidate base station in the set of candidate base stations is smaller than a predetermined distance.

Optionally, the service request carries an identity (ID) of the UE and the obtaining unit is further configured to obtain a base station standard supported by the UE and location information of the UE based on the ID of the UE; and the determination unit, for determining the set of candidate base stations of the UE according to the service request, is configured to determine the set of candidate base stations based on the base station standard supported by the UE and the location information of the UE, where a distance between a location of the UE and a location of any candidate base station in the set of candidate base stations is smaller than a predetermined distance.

Optionally, the service request carries a base station identity (ID), a public land mobile network (PLMN), carrier information and a base station standard of at least one base station, where the base station standard of the at least one base station includes the base station standard supported by the UE, and the determination unit, for determining the set of candidate base stations of the UE according to the service request, is configured to determine the at least one base station to be a candidate base station in the set of candidate base stations according to the service request.

Optionally, the obtaining unit, for obtaining the channel quality information of the at least one candidate base station, is configured to: send, by the sending unit, information about the at least one candidate base station to the UE, where the information about the at least one candidate base station includes a base station identity (ID), a public land mobile network (PLMN), carrier information and a base station standard of the at least one candidate base station; and receive, by the receiving unit, the channel quality information of the at least one candidate base station measured by the UE.

Optionally, the service request further carries channel quality information of the at least one base station, and the obtaining unit, for obtaining the channel quality information of the at least one candidate base station, is configured to obtain the channel quality information of the at least one candidate base station from the service request.

Optionally, the obtaining unit, for obtaining the QoS policy corresponding to the service type of the UE, is configured to: send, by the sending unit, a QoS policy query request to a policy and charging rules function (PCRF) entity of the UE, where the QoS policy query request is configured to request querying for a QoS policy of the UE in the PCRF and the QoS policy query request carries the service type of the UE; and receive, by the receiving unit, information about the QoS policy corresponding to the service type of the UE sent by the PCRF.

Optionally, the obtaining unit, for obtaining the resource usage information of the at least one candidate base station, is configured to: send, by the sending unit, a resource block (RB) query message to a candidate base station of the at least one candidate base station, where the RB query message is configured to query for RB usage information of the candidate base station of the at least one candidate base station, and the RB usage information of the candidate base station is one of the resource usage information of the candidate base station; and receive, by the receiving unit, the RB usage information sent by the candidate base station of the at least one candidate base station.

Optionally, the obtaining unit, for obtaining the resource usage information of the at least one candidate base station, is configured to: send, by the sending unit, a backhaul resource query message to a transport network controller of at least one transport network connected to the at least one candidate base station, where the backhaul resource query message is configured to query for backhaul resource usage information of the at least one candidate base station, and the backhaul usage information of the candidate base station is one of the resource usage information of the candidate base station; and receive, by the receiving unit, the backhaul resource usage information of the at least one candidate base station sent by the transport network controller.

Optionally, the obtaining unit, for obtaining the resource usage information of the at least one candidate base station, is configured to: send, by the sending unit, a backhaul resource query message to at least one packet data gateway (PGW) connected to the at least one candidate base station, where the backhaul resource query message is configured to query for backhaul resource usage information of the at least one candidate base station, and the backhaul usage information of the candidate base station is one of the resource usage information of the candidate base station; and receive, by the receiving unit, the backhaul resource usage information of the at least one candidate base station sent by the at least one PGW.

Optionally, the obtaining unit, for obtaining the link information of the at least one transport network connected to the at least one candidate base station, is configured to: send, by the sending unit, a link query message to a transport network controller of the at least one transport network connected to the at least one candidate base station, where the link query message is configured to query for the link information of the at least one transport network connected to the at least one candidate base station; and receive, by the receiving unit, the link information of the at least one transport network connected to the at least one candidate base station sent by the transport network controller, where the link information includes a transport network route delay and/or egress bandwidth usage information of the at least one transport network.

Optionally, the obtaining unit, for obtaining the link information of the at least one transport network connected to the at least one candidate base station, is configured to: send, by the sending unit, a route delay query message to a transport network border router of the at least one transport network connected to the at least one candidate base station, where the route delay query message is configured to query for a transport network route delay of the at least one transport network; and receive, by the receiving unit, the transport network route delay of the at least one transport network sent by the transport network border router.

Optionally, the obtaining unit, for obtaining the link information of the at least one transport network connected to the at least one candidate base station, is configured to: send, by the sending unit, an egress bandwidth query message to a transport network traffic controller of the at least one transport network connected to the at least one candidate base station, where the egress bandwidth query message is configured to query for egress bandwidth usage information of the at least one transport network; and receive, by the receiving unit, the egress bandwidth usage information of the at least one transport network sent by the transport network traffic controller.

Optionally, the obtaining unit, for obtaining the traffic control policy corresponding to the service type in the at least one transport network, is configured to: send, by the sending unit, a traffic control policy query message to a transport network controller of the at least one transport network connected to the at least one candidate base station, where the traffic control policy query message is configured to query for the traffic control policy of the at least one transport network; and receive, by the receiving unit, the traffic control policy of the at least one transport network sent by the transport network controller.

Optionally, the obtaining unit, for obtaining the traffic control policy corresponding to the service type in the at least one transport network, is configured to: send, by the sending unit, a traffic control policy query message to a transport network traffic controller of the at least one transport network connected to the at least one candidate base station, where the traffic control policy query message is configured to query for the traffic control policy of the at least one transport network; and receive, by the receiving unit, the traffic control policy of the at least one transport network sent by the transport network traffic controller.

Optionally, the information about the serving base station includes an ID, a base station standard, carrier information and PLMN information of the serving base station.

In a fourth aspect, a user equipment is provided. The user equipment includes: a sending unit, configured to send a service request to a wireless network controller of the user equipment; and a receiving unit, configured to receive a service acceptance message sent by the wireless controller according to the service request, where the service acceptance message carries information about a serving base station, the serving base station is a candidate base station determined by the wireless controller from a set of candidate base stations of the user equipment based on a predetermined rule, the set of candidate base stations of the user equipment includes at least one candidate base station of the user equipment, and the set of candidate base stations of the user equipment is determined by the wireless controller according to the service request.

Optionally, the service request carries a service type of the user equipment; and the wireless controller determining the serving base station based on the predetermined rule includes the wireless controller determining the serving base station based on at least one of following information: a quality of service (QoS) policy corresponding to the service type, channel quality information of the at least one candidate base station, resource usage information of the at least one candidate base station, link information of at least one transport network connected to the at least one candidate base station and a traffic control policy corresponding to the service type in the at least one transport network.

Optionally, the service request further carries a base station standard supported by the user equipment and location information of the user equipment, which are used by the wireless controller to determine the set of candidate base stations of the user equipment based on the base station standard supported by the user equipment and the location information of the user equipment, where a distance between a location of the user equipment and a location of any candidate base station in the set of candidate base stations of the user equipment is smaller than a predetermined distance.

Optionally, the service request further carries a base station identity (ID), a public land mobile network (PLMN), carrier information and a base station standard of at least one base station, where the base station standard of the at least one base station includes a base station standard supported by the user equipment, and the base station identity (ID), the public land mobile network (PLMN), the carrier information and the base station standard of the at least one base station are used by the wireless controller to determine the at least one base station to be a candidate base station in the set of candidate base stations of the user equipment.

Optionally, the service request further carries an identity (ID) of the user equipment, which is used by the wireless controller to obtain a base station standard supported by the user equipment and location information of the user equipment based on the ID of the user equipment and determine the set of candidate base stations based on the base station standard supported by the user equipment and the location information of the user equipment, where a distance between a location of the user equipment and a location of any candidate base station in the set of candidate base stations is smaller than a predetermined distance.

Optionally, the quality of service (QoS) policy corresponding to the service type includes a QoS policy obtained by the wireless controller from QoS policy information stored in the wireless controller; or the QoS policy corresponding to the service type includes a QoS policy obtained by the wireless controller from a policy and charging rules function (PCRF) entity of the user equipment.

Optionally, the channel quality information of the at least one candidate base station includes channel quality information extracted by the wireless controller from information carried in the service request of the user equipment; or the channel quality information of the at least one candidate base station includes channel quality information obtained by the wireless controller by querying the at least one candidate base station.

Optionally, the resource usage information of the at least one candidate base station includes a resource block (RB) usage message obtained by the wireless controller by querying the at least one candidate base station; or the resource usage information of the at least one candidate base station includes a backhaul resource usage message obtained by the wireless controller by querying a transport network controller connected to the at least one candidate base station; or the resource usage information of the at least one candidate base station includes a backhaul resource usage message obtained by the wireless controller by querying at least one packet data gateway (PGW) connected to the at least one candidate base station.

Optionally, the link information of the at least one transport network connected to the at least one candidate base station includes transport network link information obtained by the wireless controller by querying a transport network controller of the at least one transport network connected to the at least one candidate base station; or the link information of the at least one transport network connected to the at least one candidate base station includes a transport network route delay obtained by the wireless controller by querying a border router of the at least one transport network connected to the at least one candidate base station; or the link information of the at least one transport network connected to the at least one candidate base station includes egress bandwidth usage information obtained by the wireless controller by querying a transport network traffic controller of the at least one transport network connected to the at least one candidate base station.

Optionally, the traffic control policy corresponding to the service type in the at least one transport network includes a traffic control policy obtained by the wireless controller by querying a transport network controller of the at least one transport network connected to the at least one candidate base station; or the traffic control policy corresponding to the service type in the at least one transport network includes a traffic control policy obtained by the wireless controller by querying a transport network traffic controller of the at least one transport network connected to the at least one candidate base station.

Based on the technical solutions above, in the service access method, user equipment and wireless controller according to embodiments of the invention, by determining at least one candidate base station of the UE and determining a serving base station of the UE from the at least one candidate base station based on a predetermined rule, the wireless controller can flexibly provide a serving base station for the UE to access.

### BRIEF DESCRIPTION OF THE DRAWINGS

To clearly illustrate technical solutions according to the embodiments of the invention, drawings to be used in the description of the embodiments or the conventional technology are described briefly as follows. Apparently, the drawings in the following description only illustrate some embodiments of the invention. Other drawings may be obtained by those skilled in the art based on these drawings without any creative work.

FIG. 1 is a schematic diagram of a network architecture with segment control of a QoS policy according to an embodiment of the invention;

FIG. 2 is a schematic diagram of a network architecture with control and bearer separated according to an embodiment of the invention;

FIG. 3 is a flowchart of a service access method according to an embodiment of the invention;

FIG. 4 is an interaction flowchart of service access according to an embodiment of the invention;

FIG. 5 is another interaction flowchart of service access according to an embodiment of the invention;

FIG. 6 is yet another interaction flowchart of service access according to an embodiment of the invention;

FIG. 7 is a structural schematic diagram of a wireless controller according to an embodiment of the invention;

FIG. 8 is a flowchart of another service access method according to an embodiment of the invention;

FIG. 9 is a structural schematic diagram of a user equipment according to an embodiment of the invention;

FIG. 10 is another structural schematic diagram of a wireless controller according to an embodiment of the invention; and

FIG. 11 is another structural schematic diagram of a user equipment according to an embodiment of the invention.

### DETAILED DESCRIPTION OF THE EMBODIMENTS

Technical solutions according to the embodiments of the invention are described clearly and completely hereinafter in conjunction with the drawings of the embodiments of the invention. Apparently, the described embodiments are only a few but not all of embodiments of the invention. Any other embodiments obtained by those skilled in the art based on the embodiments in the present invention without any creative work fall within the scope of protection of the invention.

To facilitate understanding the embodiments of the invention, some elements to be introduced in the description of the embodiments of the invention are firstly described herein.

FIG. 1 is a schematic diagram of a network architecture with segment control of a QoS policy according to an embodiment of the invention. In FIG. 1, a base station performs a QoS control on link 1 and link 2, and a transport network performs a traffic monitor on link 3 and link 4. Link 1 may be affected by a standard of the base station, an operator that the base station belongs to (PLMN), channel qualities of a UE at different positions and a QoS policy at an RAN side. Link 2 may be affected by a backhaul transmission capability of the base station and an instant backhaul bandwidth occupation rate. Link 3 may be affected by a transmission capability, a route delay and a traffic control policy of a transport network connected to the base station. Link 4 may be affected by a transport network egress bandwidth and an instant egress bandwidth occupation rate of the transport network connected to the base station.

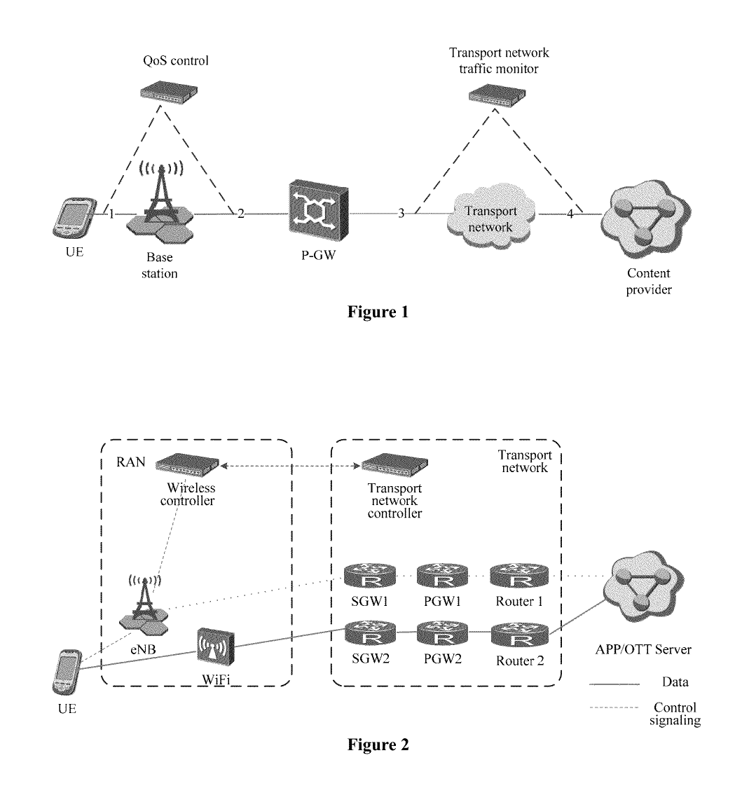

FIG. 2 is a schematic diagram of a network architecture with control and bearer separated according to an embodiment of the invention. In FIG. 2, a control function at the RAN side is implemented by a wireless controller. The wireless controller has a base station control function and a core network control function of a conventional network RAN and can control base stations of different standards, such as a base station and a wireless fidelity (WiFi) in FIG. 2. A control function of the transport network is implemented by a transport network controller. A node at the transport network side is simplified as a router. As illustrated in FIG. 2, a control signaling and a bearer signaling of a UE are separated. The control signaling of the UE reaches an (APP/OTT) server through base stations of different standards (such as eNB, Wifi), a Wireless Controller, a transport network controller or a router, and the bearer signaling of the UE is through base stations of different standards, a service gateway, a packet data gateway or an APP/OTT Server.

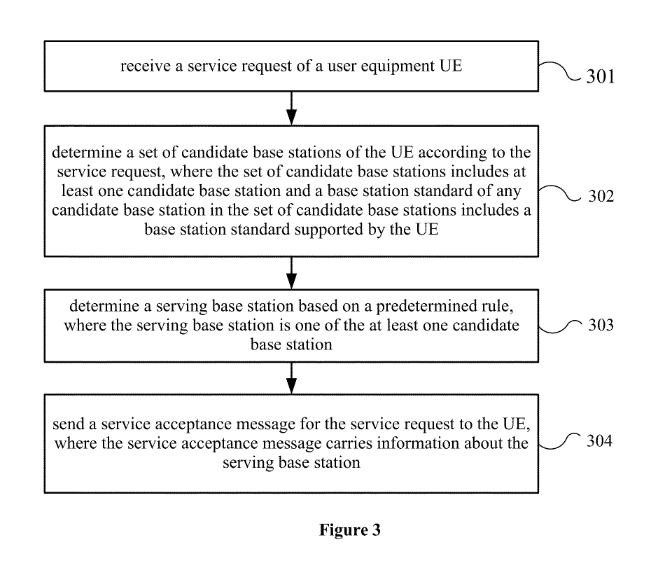

FIG. 3 is a flowchart of a service access method according to an embodiment of the invention. The method illustrated in FIG. 3 is performed by a wireless controller.

Step 301 includes receiving a service request of a user equipment (UE).

Step 302 includes determining a set of candidate base stations of the UE according to the service request.

The set of candidate base stations includes at least one candidate base station, and a base station standard of any candidate base station in the set of candidate base stations includes a base station standard supported by the UE.

The base station standard supported by the UE may include GSM or CDMA.

Step 303 includes determining a serving base station based on a predetermined rule.

The serving base station is one of the at least one candidate base station.

Step 304 includes sending a service acceptance message for the service request to the UE.

The service acceptance message carries information about the serving base station.

In the embodiment of the invention, by determining the at least one candidate base station of the UE and determining the serving base station of the UE from the at least one candidate base station based on the predetermined rule, the wireless controller can flexibly provide a serving base station for the UE to access.

It should be noted that the method according to the embodiment of the invention is applicable to not only the network architecture with control and bearer separated in FIG. 2, but also the network architecture illustrated in FIG. 1, including but not limited to a network architecture of an LTE system.

In the embodiment of the invention, the predetermined rule may be a selection policy specified by an operator, a selection policy determined based on a certain standard or other selection policy configured artificially.

The service request carries a service type of the UE; and determining the serving base station based on the predetermined rule may be implemented as determining the serving base station based on at least one of the following information: a quality of service (QoS) policy corresponding to the service type, channel quality information of the at least one candidate base station, resource usage information of the at least one candidate base station, link information of at least one transport network connected to the at least one candidate base station and a traffic control policy corresponding to the service type in the at least one transport network. Based on the selection conditions described above, the wireless controller may select an appropriate base station from the at least one candidate base station in the set of candidate base stations to serve as a serving base station of the UE. In the embodiment of the invention, based on transmission conditions of the candidate base station, which is to be accessed by the UE, at a user plane bearer side and a transport network side, a serving base station with good comprehensive transmission condition can be selected from the candidate base stations of the UE, and thus a high-quality service access path can be established for the UE.

Furthermore, before determining the serving base station based on the predetermined rule, the method further includes: obtaining at least one of the following information: the quality of service (QoS) policy corresponding to the service type, the channel quality information of the at least one candidate base station, the resource usage information of the at least one candidate base station, the link information of the at least one transport network connected to the at least one candidate base station and the traffic control policy corresponding to the service type in the at least one transport network. In the embodiment of the invention, transmission conditions of the base station at a user plane bearer side and a transport network side are obtained, which provides a selection condition for the wireless controller to determine a high-quality serving base station of the UE.

Optionally, in an embodiment, the service request carries a base station standard supported by the UE and location information of the UE; and determining the set of candidate base stations of the UE according to the service request may be implemented as determining the set of candidate base stations based on the base station standard supported by the UE and the location information of the UE, where a distance between a location of the UE and a location of any candidate base station in the set of candidate base stations is smaller than a predetermined distance. The predetermined distance may be specified by a protocol or specified by an operator, or specified artificially otherwise, which is not limited in the embodiment of the invention. In the embodiment of the invention, based on the base station standard supported by the UE and the location of the UE, a candidate base station which can support the UE can be selected from base stations within a certain range around the UE, and thus the range in which the wireless controller determines a serving base station of the UE is narrowed. In addition, the service request carries the base station standard supported by the UE, therefore the wireless controller does not need to store information about the base station standard supported by the UE, and thus storage overhead of the wireless controller is reduced.

Furthermore, obtaining the channel quality information of the at least one candidate base station is implemented as: sending information about the at least one candidate base station to the UE, where the information about the at least one candidate base station includes a base station identity (ID) of the at least one candidate base station, a public land mobile network (PLMN) of the at least one candidate base station, carrier information of the at least one candidate base station and a base station standard of the at least one candidate base station; and receiving the channel quality information of the at least one candidate base station measured by the UE. In the embodiment of the invention, the channel quality information of each candidate base station can be obtained by querying the candidate base stations for the channel quality information respectively, thereby providing a reference condition of channel quality for the wireless controller to determine the serving base station of the UE.

In a country or a district, a cellular mobile communication network with a standard of an operator is called as a PLMN. The PLMN is a network established and operated by a government or an operator authorized by the government for the purpose of providing a land mobile communications service for the public. The network can be interconnected with other communication networks such as a public switched telephone network (PSTN) to form a communication network in a scale of the whole district or country. Since one service corresponds to only one standard of a cellular mobile communication network, the PLMN may be simply considered as an operator in the embodiment of the invention.

The carrier information of the candidate base station may include information about a central frequency, a carrier bandwidth or a carrier range of the candidate base station.

Optionally, in another embodiment, the service request carries an ID of the UE; and determining the set of candidate base stations of the UE according to the service request is implemented as: obtaining a base station standard supported by the UE and location information of the UE based on the ID of the UE; and determining the set of candidate base stations based on the base station standard supported by the UE and the location information of the UE, where a distance between a location of the UE and a location of any candidate base station in the set of candidate base stations is smaller than a predetermined distance. In the embodiment of the invention, the base station standard supported by the UE and the location of the UE are obtained based on the ID of the UE, so that a candidate base station which can support the UE can be selected from base stations within a certain range around the UE, and thus the range in which the wireless controller determines the serving base station of the UE is narrowed. In addition, the service request carries only the ID of the UE, which to some degree reduces an occupation of an uplink bandwidth.

Furthermore, obtaining the channel quality information of the at least one candidate base station is implemented as: sending information about the at least one candidate base station to the UE, where the information about the at least one candidate base station includes a base station identity (ID), a public land mobile network (PLMN), carrier information and a base station standard of the at least one candidate base station; and receiving the channel quality information of the at least one candidate base station measured by the UE. In the embodiment of the invention, the channel quality information of each candidate base station can be obtained by querying the candidate base stations for the channel quality information respectively, thereby providing a reference condition of channel quality for the wireless controller to determine the serving base station of the UE.

Optionally, in another embodiment, the service request carries a base station identity (ID), a public land mobile network (PLMN), carrier information and a base station standard of at least one base station, where the base station standard of the at least one base station include a base station standard supported by the UE; and determining the set of candidate base stations of the UE according to the service request is implemented as determining the at least one base station to be a candidate base station in the set of candidate base stations according to the service request. In the embodiment of the invention, the UE obtains information about, for example, the candidate base station of the UE based on the base station standard supported by the UE, which narrows the range in which the wireless controller determines the serving base station of the UE. In addition, information about the candidate base station is carried in the service request of the UE, so that the wireless controller does not need to calculate for the candidate base station of the UE, thereby reducing operation overhead of the wireless controller.

Furthermore, the service request further carries the channel quality information of the at least one base station; and obtaining the channel quality information of the at least one candidate base station includes obtaining the channel quality information of the at least one candidate base station from the service request. In the embodiment of the invention, the UE directly measures the channel quality information of the candidate base station and sends the measured channel quality information to the wireless controller, which provides a reference condition of channel quality for the wireless controller to determine the serving base station of the UE. In addition, by directly measuring the channel quality information of the candidate base station and sending the measured channel quality information to the wireless controller by the UE, steps of querying for and obtaining the channel quality of the candidate base station by the wireless controller can be reduced, and a response delay after the UE sends the request is reduced to some degree.

Optionally, in an embodiment, obtaining the QoS policy corresponding to the service type of the UE may be implemented as obtaining the QoS policy corresponding to the service type of the UE from stored QoS policies. In the embodiment of the invention, the QoS policy corresponding to the service type of the UE is obtained, which provides a reference condition of the QoS policy for the wireless controller to determine the serving base station of the UE. In addition, the QoS policy corresponding to the service type of the UE is obtained from the QoS policies stored in the wireless controller, which may improve obtaining the QoS policy and to some degree reduce a response delay after the UE sends the request.

Optionally, in another embodiment, obtaining the QoS policy corresponding to the service type of the UE may be implemented as: sending a QoS policy query request to a policy and charging rules function (PCRF) entity of the UE, where the QoS policy query request is configured to request querying for a QoS policy of the UE in the PCRF and the QoS policy query request carries the service type of the UE; and receiving information about the QoS policy corresponding to the service type of the UE sent by the PCRF. In the embodiment of the invention, the QoS policy corresponding to the service type of the UE is obtained from the PCRF, which provides a reference condition of the QoS policy for the wireless controller to determine the serving base station of the UE. In addition, a real-time QoS policy corresponding to the service type of the UE can be obtained by obtaining the QoS policy corresponding to the service type of the UE from the PCRF.

Optionally, in an embodiment, obtaining the resource usage information of the at least one candidate base station may be implemented as: sending a resource block (RB) query message to a candidate base station of the at least one candidate base station, where the RB query message is configured to query for RB usage information of the candidate base station of the at least one candidate base station; and receiving the RB usage information sent by the candidate base station of the at least one candidate base station. In the embodiment of the invention, the RB usage information of the candidate base station is obtained, which provides a reference condition of RB usage for the wireless controller to determine the serving base station of the UE.

Optionally, in another embodiment, obtaining the resource usage information of the at least one candidate base station may be implemented as: sending a backhaul resource query message to a transport network controller of at least one transport network connected to the at least one candidate base station, where the backhaul resource query message is configured to query for backhaul resource usage information of the at least one candidate base station; and receiving the backhaul resource usage information of the at least one candidate base station sent by the transport network controller. In the embodiment of the invention, the backhaul resource usage information of the candidate base station is obtained, which provides a reference condition of backhaul resource usage for the wireless controller to determine the serving base station of the UE.

Optionally, in another embodiment, obtaining the resource usage information of the at least one candidate base station may be implemented as: sending a backhaul resource query message to at least one packet data gateway (PGW) connected to the at least one candidate base station, where the backhaul resource query message is configured to query for backhaul resource usage information of the at least one candidate base station; and receiving the backhaul resource usage information of the at least one candidate base station sent by the at least one PGW. In the embodiment of the invention, the backhaul resource usage information of the candidate base station is obtained, which provides a reference condition of backhaul resource usage for the wireless controller to determine the serving base station of the UE.

Optionally, in an embodiment, obtaining the link information of the at least one transport network connected to the at least one candidate base station may be implemented as: sending a link query message to a transport network controller of the at least one transport network connected to the at least one candidate base station, where the link query message is configured to query for the link information of the at least one transport network connected to the at least one candidate base station; and receiving the link information of the at least one transport network connected to the at least one candidate base station sent by the transport network controller, where the link information includes a transport network route delay and/or egress bandwidth usage information of the at least one transport network. In the embodiment of the invention, the link information of the transport network connected to the candidate base station is obtained, which provides a reference condition of a transport network link for the wireless controller to determine the serving base station of the UE.

Optionally, in another embodiment, obtaining the link information of the at least one transport network connected to the at least one candidate base station may be implemented as: sending a route delay query message to a transport network border router of the at least one transport network connected to the at least one candidate base station, where the route delay query message is configured to query for a transport network route delay of the at least one transport network; and receiving the transport network route delay of the at least one transport network sent by the transport network border router. In the embodiment of the invention, the link delay information of the transport network connected to the candidate base station is obtained, which provides a reference condition of the transport network route delay for the wireless controller to determine the serving base station of the UE.

Optionally, in another embodiment, obtaining the link information of the at least one transport network connected to the at least one candidate base station may be implemented as: sending an egress bandwidth query message to a transport network traffic controller of the at least one transport network connected to the at least one candidate base station, where the egress bandwidth query message is configured to query for egress bandwidth usage information of the at least one transport network; and receiving the egress bandwidth usage information of the at least one transport network sent by the transport network traffic controller. In the embodiment of the invention, the link egress bandwidth usage information of the transport network connected to the candidate base station is obtained, which provides a reference condition of link egress bandwidth usage of the transport network for the wireless controller to determine the serving base station of the UE.

Optionally, in an embodiment, obtaining the traffic control policy corresponding to the service type in the at least one transport network may be implemented as: sending a traffic control policy query message to a transport network controller of the at least one transport network connected to the at least one candidate base station, where the traffic control policy query message is configured to query for the traffic control policy of the at least one transport network; and receiving the traffic control policy of the at least one transport network sent by the transport network controller. In the embodiment of the invention, the traffic control policy of the transport network connected to the candidate base station is obtained from the transport network controller of the transport network, which provides a reference condition of the transport network traffic control policy for the wireless controller to determine the serving base station of the UE.

Optionally, in another embodiment, obtaining the traffic control policy corresponding to the service type in the at least one transport network may be implemented as: sending a traffic control policy query message to a transport network traffic controller of the at least one transport network connected to the at least one candidate base station, where the traffic control policy query message is configured to query for the traffic control policy of the at least one transport network; and receiving the traffic control policy of the at least one transport network sent by the transport network traffic controller. In the embodiment of the invention, the link egress bandwidth usage information of the service type of the UE in the transport network connected to the candidate base station is obtained from the transport network traffic controller of the transport network, which provides a reference condition of link egress bandwidth usage of the transport network for the wireless controller to determine the serving base station of the UE.

Optionally, in step 304, the information about the serving base station may include: an ID of the serving base station, a base station standard of the serving base station, carrier information of the serving base station and PLMN information of the serving base station.

The method according to the embodiment of the invention is further described hereinafter in conjunction with particular embodiments.

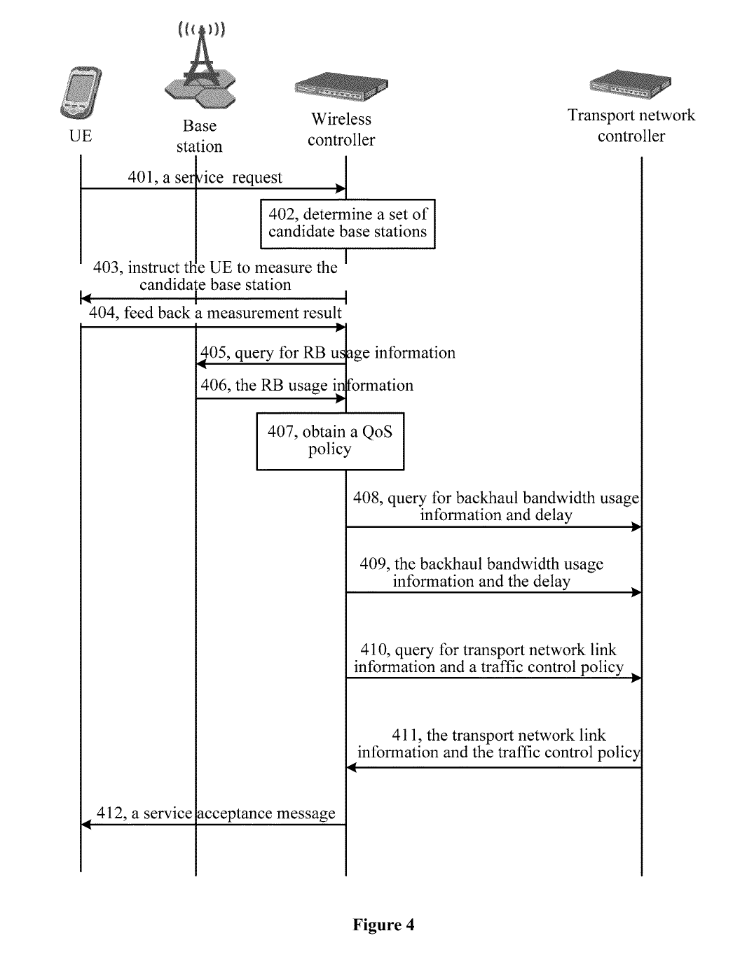

FIG. 4 is an interaction flowchart of service access according to an embodiment of the invention. The interaction method in FIG. 4 is applicable to the network architecture illustrated in FIG. 2.

In 401, a UE sends a service request.

A UE sends a service request to a Wireless Controller that the UE is subject to. The service request may carry an ID of the UE, a service type requested by the UE, location information of the UE and capability information of the UE. In the embodiment of the invention, the capability information of the UE refers to a base station standard supported by the UE.

In 402, the Wireless Controller determines a set of candidate base stations.

The Wireless Controller may determine a set of candidate base stations which can provide service to the UE based on the location and capability information of the UE. The set of candidate base stations includes at least one candidate base station. Each candidate base station has a base station standard supported by the UE.

In 403, the Wireless Controller instructs the UE to perform measurement on the candidate base station.

The Wireless Controller sends information about a candidate base station in the set of candidate base stations to the UE, and instructs the UE to measure a channel quality of the candidate base station in the set of candidate base stations. The information about the candidate base station may include an ID of the candidate base station, a PLMN that the candidate base station belongs to, and carrier information and a base station standard of the candidate base station. The carrier information of the candidate base station may be a central frequency and a carrier bandwidth of the candidate base station, or a carrier range of the candidate base station.

In 404, the UE feeds back a measurement result.

The UE measures channel quality of the candidate base station according to the information about the candidate base station sent by the Wireless Controller, and feeds back the measured channel quality to the Wireless Controller.

In 405, the Wireless Controller queries for RB usage information.

The Wireless Controller sends a resource block (RB) query message to at least one candidate base station in the set of candidate base stations. The RB query message is configured to query for RB usage information of the candidate base station. The RB usage information may be a RB occupation rate of the candidate base station.

In 406, the candidate base station feeds back the RB usage information.

The candidate base station feeds back the RB usage information to the Wireless Controller based on the current RB usage.

In 407, the Wireless Controller obtains a QoS policy.

In the embodiment of the invention, the Wireless Controller may store QoS policies corresponding to different service types. The Wireless Controller may, based on the service type carried in the service request, obtain a QoS policy corresponding to the service type stored in the Wireless Controller.

In 408, the Wireless Controller queries for backhaul bandwidth usage information.

The Wireless Controller may send a backhaul bandwidth query message to at least one transport network controller connected to the at least one candidate base station in the set of candidate base stations, for querying for backhaul bandwidth usage information for connecting to the candidate base station in the set of candidate base stations.

In 409, the transport network controller feeds back the backhaul bandwidth usage information.

The transport network controller of the at least one transport network feeds back the backhaul bandwidth usage information of the candidate base station that the Wireless Controller queries for. The backhaul bandwidth usage information may include a backhaul bandwidth occupation rate and a backhaul delay.

In 410, the Wireless Controller queries for transport network link information and a traffic control policy.

The Wireless Controller may send a link query message and a traffic control policy query message to at least one transport network controller connected to at least one candidate base station in the set of candidate base stations. The link query message and the traffic control policy query message may be sent together or separately.

The link query message is configured to query for link information of at least one transport network connected to the at least one candidate base station in the set of candidate base stations. The link information may include a transport network route delay and/or transport network egress bandwidth usage information. The transport network egress bandwidth usage information may include a transport network egress bandwidth occupation rate.

The traffic control policy query message may be configured to query for a traffic control policy corresponding to the service type in the at least one transport network controller.

In 411, the transport network controller feeds back the transport network link information and the traffic control policy.

The transport network controller of the at least one transport network controller may feed back the transport network link information and the traffic control policy according to the link query message and traffic control policy query message sent by the Wireless Controller.

In 412, the Wireless Controller sends a service acceptance message to the UE.

The Wireless Controller determines a serving base station for providing service for the UE based on the channel quality of the candidate base station, the RB usage information of the candidate base station, the QoS policy corresponding to the service type of the UE, the backhaul resource usage information of the candidate base station, the transport network information of the transport network connected to the candidate base station and the traffic control policy of the service type in the transport network connected to the candidate base station, and sends a service acceptance message to the UE. The service acceptance message may carry an ID of the serving base station, a PLMN that the serving base station belongs to, carrier information of the serving base station and a base station standard of the serving base station.

In addition, the sequence of steps 403, 405, 407, 408 and 410 is not limited in the embodiment of the invention.

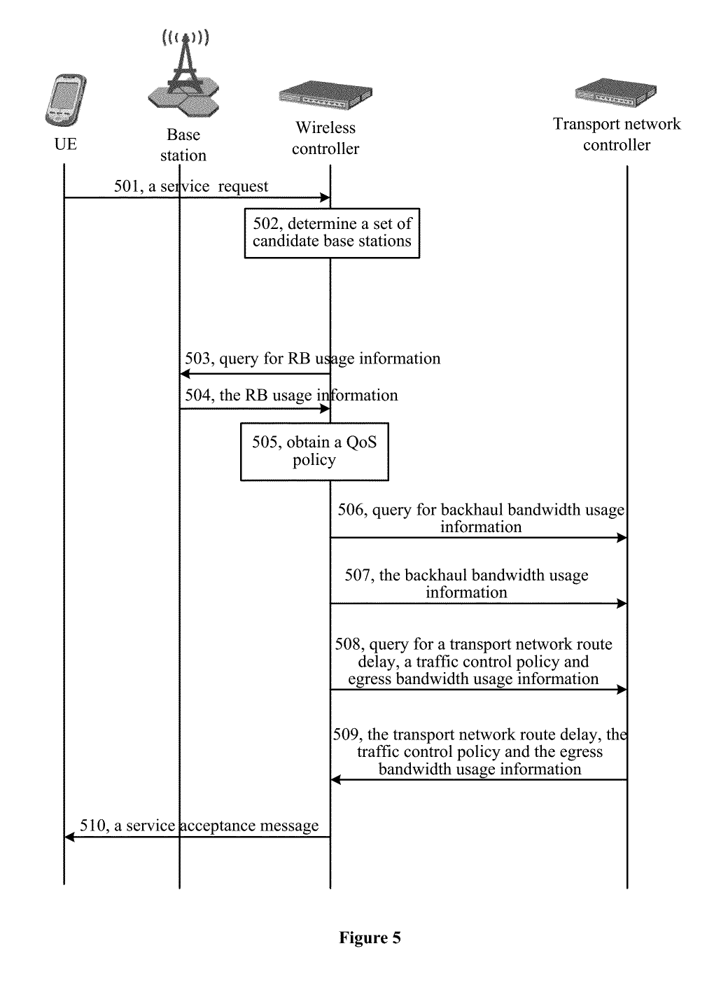

FIG. 5 is another interaction flowchart of service access according to an embodiment of the invention. The interaction method in FIG. 5 is applicable to the network architecture illustrated in FIG. 2.

In 501, a UE sends a service request.

A UE sends a service request to a Wireless Controller that the UE is subject to. The service request may carry an ID of the UE, a service type requested by the UE, capability information of the UE and a channel quality measured by the UE. The channel quality measured by the UE refers to a channel quality of a base station which supports service to the UE. In the embodiment of the invention, the UE may scan for a base station with a base station standard supported by the UE before initiating the service quest, and perform a measurement on the base station scanned for to obtain a channel quality of the base station. Based on results of the scan and the measurement, capability information of the UE may be carried in the service request by the UE. The capability information of the UE may include an ID of a base station supporting the service to the UE, a PLMN that the base station belongs to and carrier information of the base station. In addition, the channel quality of the base station supporting service to the UE may be carried in the service request by the UE.

In 502, the Wireless Controller determines a set of candidate base stations.

The Wireless Controller may determine a set of candidate base stations which provide service to the UE based on the capability information carried in the service request of the UE. The set of candidate base stations may include the base station referred to in the capability information.

In 503, the Wireless Controller queries for RB usage information.

Steps 530 to 510 are respectively similar as steps 405 to 412 illustrated in FIG. 4, which are not described in the embodiment of the invention.

In addition, the sequence of steps 503, 505, 506 and 508 is not limited in the embodiment of the invention.

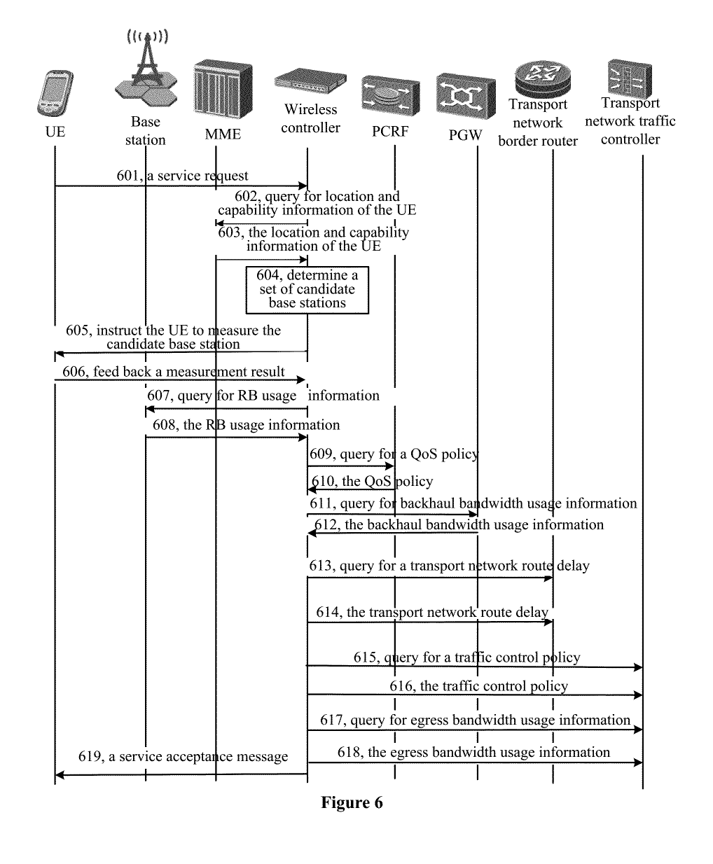

FIG. 6 is yet another interaction flowchart of service access according to an embodiment of the invention. The interaction method in FIG. 6 is applicable to the network architecture illustrated in FIG. 1.

In 601, a UE sends a service request.

A UE sends a service request to a Wireless Controller that the UE is subject to. The service request may carry an ID of the UE and a service type requested by the UE.

In 602, the Wireless Controller queries an MME for location and capability information of the UE.

The Wireless Controller sends a query message to an MME, to query for location of the UE and capability information of the UE. In the embodiment of the invention, the location of the UE and the capability information of the UE are stored in the MME, and the capability information of the UE refers to a base station standard supported by the UE. Of course, the Wireless Controller may send a query message to other device or apparatus in which the location of the UE and the capability information of the UE are stored, and the device or apparatus is not necessarily an MME, for example, the location of the UE and the capability information of the UE may be stored in a mobile switch center accessed by the UE, which is not limited in the embodiment of the invention. The Wireless Controller may query for the location of the UE and the capability information of the UE together or separately.

In 603, the MME feeds back the location of the UE and the capability information of the UE.

The MME feeds back the location of the UE and the capability information of the UE according to the query message sent by the Wireless Controller.

In 604, the Wireless Controller determines a set of candidate base stations.

The Wireless Controller may determine a set of candidate base stations which can provide service to the UE based on the location of the UE and the capability information of the UE. The set of candidate base stations includes at least one candidate base station, and each candidate base station has a base station standard supported by the UE.

In 605, the Wireless Controller instructs the UE to perform a measurement on a candidate base station.

The Wireless Controller sends information about at least one candidate base station in the set of candidate base stations to the UE, to instructs the UE to measure a channel quality of the at least one candidate base station in the set of candidate base stations. The information about the candidate base station may include an ID of the candidate base station, a PLMN that the candidate base station belongs to, and carrier information and a base station standard of the candidate base station. The carrier information of the candidate base station may be frequency information of the candidate base station.

In 606, the UE feeds back a measurement result.

The UE, based on the information about the at least one candidate base station sent by the Wireless Controller, measures the channel quality of the candidate base station, and feeds back the measured channel quality to the Wireless Controller.

In 607, the Wireless Controller queries for RB usage information.

The Wireless Controller sends a resource block (RB) resource query message to at least one candidate base station in the set of candidate base stations. The RB query message is configured to query for the RB usage information of the candidate base station. The RB usage information may be a RB occupation rate of the candidate base station.

In 608, the candidate base station feeds back the RB usage information.

The candidate base station feeds back the RB usage information to the Wireless Controller based on the current RB usage.

In 609, the Wireless Controller queries a PCRF for a QoS policy.

In the embodiment of the invention, QoS policies corresponding to different service types are stored in a PCRF. The Wireless Controller sends to the PCRF a QoS policy query message. The QoS policy query message may carry a service type of the UE.

In 610, the PCRF feeds back the QoS policy.

The PCRF obtains a QoS policy corresponding to the service type of the UE based on the service type of the UE carried in the QoS policy query message, and feeds back the QoS policy to the Wireless Controller.

In 611, the Wireless Controller queries a PGW for backhaul bandwidth usage information.

The Wireless Controller may send a backhaul bandwidth query message to at least one PGW connected to at least one candidate base station in the set of candidate base stations, to query for the backhaul bandwidth usage information of the candidate base station in the set of candidate base stations.

In 612, the PGW feeds back the backhaul bandwidth usage information.

The at least one transport network feeds back the backhaul bandwidth usage information of the candidate base station that the Wireless Controller queries for. The backhaul bandwidth usage information may include a backhaul bandwidth occupation rate.

In 613, the Wireless Controller queries a transport network border router for a transport network route delay.

The Wireless Controller may send a transport network route delay query message to a transport network border router of at least one transport network connected to at least one candidate base station in the set of candidate base stations, to query for the backhaul bandwidth usage information of the candidate base station in the set of candidate base stations.

In 614, the transport network border router feeds back the transport network route delay.

After receiving the transport network route delay query message sent by the Wireless Controller, the transport network border router of the at least one transport network connected to the at least one candidate base station in the set of candidate base stations obtains the route delay of the transport network corresponding to the transport network border router and feeds back the route delay to the Wireless Controller.

In 615, the Wireless Controller queries a transport network traffic controller for a traffic control policy.

The Wireless Controller may send a traffic control policy query message to a transport network traffic controller of at least one transport network connected to at least one candidate base station in the set of candidate base stations, to query for a traffic control policy corresponding to the service type of the UE. The traffic control policy query message may carry the service type of the UE.

In 616, the transport network traffic controller feeds back the traffic control policy.

The transport network traffic controller may obtain a traffic control policy corresponding to the service type of the UE based on the service type of the UE carried in the traffic control policy query message sent by the Wireless Controller, and feeds back the traffic control policy to the Wireless Controller.

In 617, the Wireless Controller queries the transport network traffic controller for egress bandwidth message.

The Wireless Controller may send an egress bandwidth query message to the transport network traffic controller of at least one transport network connected to at least one candidate base station in the set of candidate base stations, to query for egress bandwidth usage information of the at least one transport network connected to the candidate base station in the set of candidate base stations.

In 618, the transport network traffic controller feeds back the egress bandwidth usage information.

After receiving the egress bandwidth query message sent by the Wireless Controller, the transport network traffic controller of the at least one transport network connected to the at least one candidate base station in the set of candidate base stations obtains egress bandwidth usage information of the transport network corresponding to the transport network traffic controller, and feeds back the egress bandwidth usage information to the Wireless Controller. The egress bandwidth usage information may be an egress bandwidth occupation rate.

In 619, the Wireless Controller sends a service acceptance message to the UE.

The Wireless Controller determines a serving base station providing service for the UE based on the channel quality of the candidate base station, the RB usage information of the candidate base station, the QoS policy corresponding to the service type of the UE, the backhaul resource usage information of the candidate base station, the transport network information of the transport network connected to the candidate base station and the traffic control policy of the service type in the transport network connected to the candidate base station, and sends a service acceptance message to the UE. The service acceptance message may carry information such as an ID of the serving base station, a PLMN that the serving base station belongs to, and carrier information and a base station standard of the serving base station.

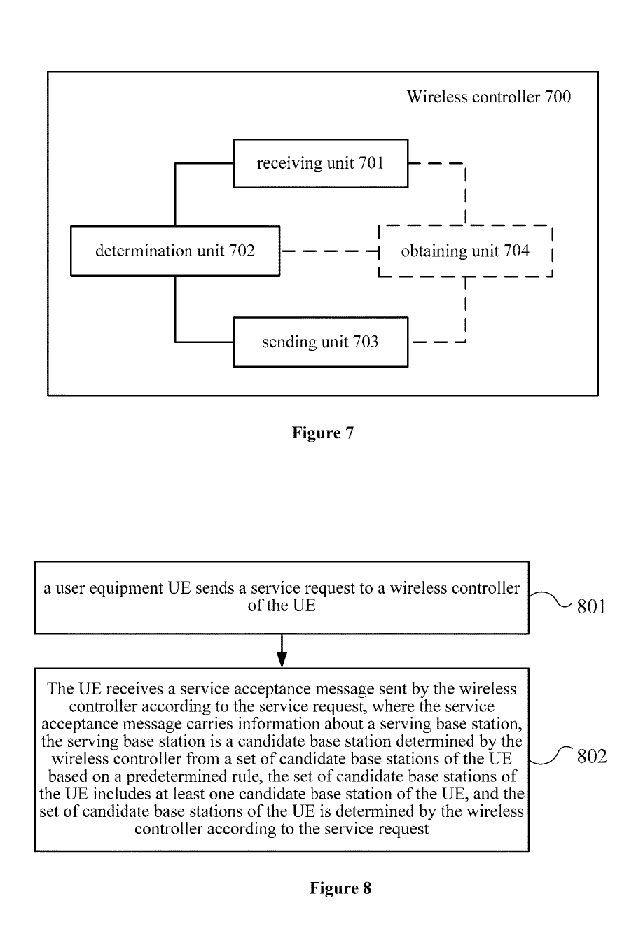

FIG. 7 is a structural schematic diagram of a wireless controller 700 according to an embodiment of the invention. The wireless controller 700 may include a receiving unit 701, a determination unit 702 and a sending unit 703.

The receiving unit 701 is configured to receive a service request of a user equipment (UE).

The determination unit 702 is configured to determine a set of candidate base stations of the UE according to the service request.

The set of candidate base stations includes at least one candidate base station, and a base station standard of any candidate base station in the set of candidate base stations include a base station standard supported by the UE.

The determination unit 702 is further configured to determine a serving base station based on a predetermined rule.

The serving base station is one of the at least one candidate base station.

The sending unit 703 is configured to send a service acceptance message for the service request to the UE.

The service acceptance message carries information about the serving base station.

In the embodiment of the invention, the wireless controller 700 determines at least one candidate base station of the UE and determines a serving base station from the at least one candidate base station based on a predetermined rule, so that the wireless controller can flexibly provide a serving base station for the UE to access.

It should be noted that the wireless controller 700 according to the embodiment of the invention is applicable to not only the network architecture with control and bearer separated in FIG. 2, but also the network architecture illustrated in FIG. 1, including but not limited to a network architecture of an LTE system.

In the embodiment of the invention, the predetermined rule may be a selection policy specified by an operator, a selection policy determined based on a certain standard or any other selection policy configured artificially.

The service request carries a service type of the UE; and the determination unit 702, for determining the serving base station based on the predetermined rule, is configured to determine the serving base station based on at least one of the following information: a quality of service (QoS) policy corresponding to the service type, channel quality information of the at least one candidate base station, resource usage information of the at least one candidate base station, link information of at least one transport network connected to the at least one candidate base station and a traffic control policy corresponding to the service type in the at least one transport network. Based on the selection conditions described above, the wireless controller may select an appropriate base station from the at least one candidate base station in the set of candidate base stations to serve as a serving base station of the UE. In the embodiment of the invention, based on transmission conditions of the candidate base station, which is to be accessed by the UE, at a user plane bearer side and a transport network side, a serving base station with a good comprehensive transmission condition may be selected by the wireless controller 700 from the candidate base stations of the UE, thereby establishing a high-quality service access path for the UE.

Optionally, as illustrated in FIG. 7, the wireless controller 700 may further include an obtaining unit 704. The obtaining unit 704 is configured to obtain at least one of the following information: the quality of service (QoS) policy corresponding to the service type, the channel quality information of the at least one candidate base station, the resource usage information of the at least one candidate base station, the link information of at least one transport network connected to the at least one candidate base station and the traffic control policy corresponding to the service type in the at least one transport network. In the embodiment of the invention, transmission conditions of the base station at the user plane bearer side and the transport network side are obtained by the wireless controller 700, which provides a selection condition for the wireless controller to determine a high-quality serving base station for the UE.

Optionally, in an embodiment, the service request carries a base station standard supported by the UE and location information of the UE; and the determination unit 702, for determining the set of candidate base stations of the UE according to the service request, is configured to determine the set of candidate base stations based on the base station standard supported by the UE and the location information of the UE. A distance between a location of the UE and a location of any candidate base station in the set of candidate base stations is smaller than a predetermined distance. The predetermined distance may be specified by a protocol, or specified by an operator, or specified artificially otherwise, which is not limited here in the embodiment of the invention. In the embodiment of the invention, based on the base station standard supported by the UE and the location of the UE, a candidate base station which can support the UE is selected by the wireless controller 700 from base stations within a certain range around the UE, thus the range in which the wireless controller determines the serving base station of the UE is narrowed. In addition, the service request carries the base station standard supported by the UE, so that the wireless controller does not need to store information about the base station standard supported by the UE, and thus storage overhead of the wireless controller 700 is reduced.

Furthermore, the obtaining unit 704, for obtaining the channel quality information of the at least one candidate base station, is configured to: send, by the sending unit 703, information about the at least one candidate base station to the UE, where the information about the at least one candidate base station includes a base station identity (ID), a public land mobile network (PLMN), carrier information and a base station standard of the at least one candidate base station; and receive, by the receiving unit 701, the channel quality information of the at least one candidate base station measured by the UE. In the embodiment of the invention, the wireless controller 700 obtains the channel quality information of each candidate base station by querying the candidate base stations for the channel quality information respectively, thereby providing a reference condition of channel quality for the wireless controller 700 to determine the serving base station of the UE.

Optionally, in another embodiment, the service request carries an identity (ID) of the UE; and the obtaining unit 704 is further configured to obtain a base station standard supported by the UE and location information of the UE based on the ID of the UE; and the determination unit 702, for determining the set of candidate base stations of the UE according to the service request, is configured to determine the set of candidate base stations based on the base station standard supported by the UE and the location information of the UE, where a distance between a location of the UE and a location of any candidate base station in the set of candidate base stations is smaller than a predetermined distance. In the embodiment of the invention, the base station standard supported by the UE and the location of the UE are obtained by the wireless controller 700 based on the ID of the UE, so that a candidate base station which can support the UE can be selected from base stations within a certain range around the UE, thus the range in which the wireless controller determines a serving base station of the UE is narrowed. In addition, the service request carries only the ID of the UE, which to some degree reduces occupation of an uplink bandwidth.

Furthermore, the obtaining unit 704, for obtaining the channel quality information of the at least one candidate base station, is configured to: send, by the sending unit 703, information about the at least one candidate base station to the UE, where the information about the at least one candidate base station includes a base station identity (ID), a public land mobile network (PLMN), carrier information and a base station standard of the at least one candidate base station; and receive, by the receiving unit 701, the channel quality information of the at least one candidate base station measured by the UE. In the embodiment of the invention, the wireless controller 700 may obtain the channel quality information of each candidate base station by querying the candidate base stations for the channel quality information respectively, thereby providing a reference condition of channel quality for the wireless controller 700 to determine the serving base station of the UE.

Optionally, in another embodiment, the service request carries a base station identity (ID), a public land mobile network (PLMN), carrier information and a base station standard of at least one base station, where the base station standard of the at least one base station include a base station standard supported by the UE; and the determination unit 702, for determining the set of candidate base stations of the UE according to the service request, is configured to determine the at least one base station to be a candidate base station in the set of candidate base stations according to the service request. In the embodiment of the invention, the UE obtains information such as a candidate base station of the UE based on the base station standard supported by the UE, which narrows the range in which the wireless controller 700 determines a serving base station for the UE. In addition, information about the candidate base station is carried in the service request of the UE, so that the wireless controller 700 does not need to calculate for the candidate base station of the UE, thereby reducing operation overhead of the wireless controller.

Furthermore, the service request further carries the channel quality information of the at least one base station; and the obtaining unit 704, for obtaining the channel quality information of the at least one candidate base station, is configured to obtain the channel quality information of the at least one candidate base station from the service request. In the embodiment of the invention, the UE directly measures channel quality information of the candidate base station and sends the channel quality information to the wireless controller 700, which provides a reference condition of channel quality for the wireless controller 700 to determine a serving base station of the UE. In addition, by directly measuring the channel quality information of the candidate base station and sending the measured channel quality information to the wireless controller 700 by the UE, steps of querying for and obtaining the channel quality of the candidate base station by the wireless controller 700 are reduced, and to some degree a response delay after the UE sends the request is reduced.

Optionally, in an embodiment, the obtaining unit 704, for obtaining the QoS policy corresponding to the service type of the UE, is configured to: send, by the sending unit 703, a QoS policy query request to a policy and charging rules function (PCRF) entity of the UE, where the QoS policy query request is configured to request querying for the QoS policy of the UE in the PCRF, where the QoS policy query request carries the service type of the UE; and receive, by the receiving unit 701, information about the QoS policy corresponding to the service type of the UE sent by the PCRF. In the embodiment of the invention, the QoS policy corresponding to the service type of the UE is obtained by the wireless controller 700, which provides a reference condition of the Qos policy for the wireless controller 700 to determine a serving base station of the UE. In addition, the QoS policy corresponding to the service type of the UE is obtained from the QoS policies stored in the wireless controller 700, which may improve obtaining the QoS policy and to some degree reduce a response delay after the UE sends the request.

Optionally, in an embodiment, the obtaining unit 704, for obtaining the QoS policy corresponding to the service type of the UE, is configured to obtain the QoS policy corresponding to the service type of the UE from QoS policies stored in the wireless controller 700. In the embodiment of the invention, the wireless controller 700 obtains the QoS policy corresponding to the service type of the UE from a PCRF, which provides a reference condition of the QoS policy for the wireless controller 700 to determine the serving base station of the UE. In addition, the wireless controller 700 can obtain a real-time QoS policy corresponding to the service type of the UE by obtaining the QoS policy corresponding to the service type of the UE from the PCRF.

Optionally, in an embodiment, the obtaining unit 704, for obtaining the resource usage information of the at least one candidate base station, is configured to: send, by the sending unit 703, a resource block (RB) query message to the candidate base station of the at least one candidate base station, where the RB query message is configured to query for the RB usage information of the candidate base station of the at least one candidate base station; and receive, by the receiving unit 701, the RB usage information sent by the candidate base station of the at least one candidate base station. In the embodiment of the invention, the wireless controller 700 obtains the RB usage information of the candidate base station, which provides a reference condition of RB usage for the wireless controller 700 to determine the serving base station of the UE.

Optionally, in an embodiment, the obtaining unit 704, for obtaining the resource usage information of the at least one candidate base station, is configured to: send, by the sending unit 703, a backhaul resource query message to a transport network controller of at least one transport network connected to the at least one candidate base station, where the backhaul resource query message is configured to query for backhaul resource usage information of the at least one candidate base station; and receive, by the receiving unit 701, the backhaul resource usage information of the at least one candidate base station sent by the transport network controller. In the embodiment of the invention, the backhaul resource usage information of the candidate base station is obtained by the wireless controller 700, which provides a reference condition of backhaul resource usage for the wireless controller 700 to determine the serving base station of the UE.

Optionally, in an embodiment, the obtaining unit 704, for obtaining the resource usage information of the at least one candidate base station, is configured to: send, by the sending unit 703, a backhaul resource query message to at least one packet data gateway (PGW) connected to the at least one candidate base station, where the backhaul resource query message is configured to query for backhaul resource usage information of the at least one candidate base station; and receive, by the receiving unit 701, the backhaul resource usage information of the at least one candidate base station sent by the at least one PGW. In the embodiment of the invention, the backhaul resource usage information of the candidate base station is obtained by the wireless controller 700, which provides a reference condition of backhaul resource usage for the wireless controller 700 to determine the serving base station of the UE.

Optionally, in an embodiment, the obtaining unit 704, for obtaining the link information of at least one transport network connected to the at least one candidate base station, is configured to: send, by the sending unit 703, a link query message to a transport network controller of the at least one transport network connected to the at least one candidate base station, where the link query message is configured to query for the link information of the at least one transport network connected to the at least one candidate base station; and receive, by the receiving unit 701, the link information of the at least one transport network connected to the at least one candidate base station sent by the transport network controller, where the link information includes a transport network route delay and/or egress bandwidth usage information of the at least one transport network. In the embodiment of the invention, the link information of the transport network connected to the candidate base station is obtained by the wireless controller 700, which provides a reference condition of a transport network link for the wireless controller 700 to determine the serving base station of the UE.

Optionally, in an embodiment, the obtaining unit 704, for obtaining the link information of at least one transport network connected to the at least one candidate base station, is configured to: send, by the sending unit 703, a route delay query message to a transport network border router of the at least one transport network connected to the at least one candidate base station, where the route delay query message is configured to query for the transport network route delay of the at least one transport network; and receive, by the receiving unit 701, the transport network route delay of the at least one transport network sent by the transport network border router. In the embodiment of the invention, the link delay information of the transport network connected to the candidate base station is obtained by the wireless controller 700, which provides a reference condition of a transport network link delay for the wireless controller 700 to determine the serving base station of the UE.

Optionally, in an embodiment, the obtaining unit 704, for obtaining the link information of at least one transport network connected to the at least one candidate base station, is configured to: send, by the sending unit 703, an egress bandwidth query message to a transport network traffic controller of the at least one transport network connected to the at least one candidate base station, where the egress bandwidth query message is configured to query for the egress bandwidth usage information of the at least one transport network; and receive, by the receiving unit 701, the egress bandwidth usage information of the at least one transport network sent by the transport network traffic controller. In the embodiment of the invention, the link egress bandwidth usage information of the transport network connected to the candidate base station is obtained by the wireless controller 700, which provides a reference condition of transport network link egress bandwidth usage for the wireless controller 700 to determine the serving base station of the UE.

Optionally, in an embodiment, the obtaining unit 704, for obtaining the traffic control policy corresponding to the service type in the at least one transport network, is configured to: send, by the sending unit 703, a traffic control policy query message to a transport network controller of the at least one transport network connected to the at least one candidate base station, where the traffic control policy query message is configured to query for the traffic control policy of the at least one transport network; and receive, by the receiving unit 701, the traffic control policy of the at least one transport network sent by the transport network controller. In the embodiment of the invention, the traffic control policy of the transport network connected to the candidate base station is obtained by the wireless controller 700 from the transport network controller of the transport network, which provides a reference condition of the transport network traffic control policy for the wireless controller 700 to determine the serving base station of the UE.

Optionally, in an embodiment, the obtaining unit 704, for obtaining the traffic control policy corresponding to the service type in the at least one transport network, is configured to: send, by the sending unit 703, a traffic control policy query message to a transport network traffic controller of the at least one transport network connected to the at least one candidate base station, where the traffic control policy is configured to query for the traffic control policy of the at least one transport network; and receive, by the receiving unit 701, the traffic control policy of the at least one transport network sent by the transport network traffic controller. In the embodiment of the invention, link egress bandwidth usage information of the service type of the UE in the transport network connected to the candidate base station is obtained by the wireless controller 700 from the transport network traffic controller of the transport network, which provides a reference condition of link egress bandwidth usage of the transport network for the wireless controller 700 to determine the serving base station of the UE.

Optionally, the information about the serving base station may include an ID, a base station standard, carrier information and PLMN information of the serving base station.

In addition, the wireless controller 700 may also perform the method in FIG. 3, and has the functions of the wireless controller in the embodiments illustrated in FIGS. 4 to 6, and particular implementation thereof may refer to the embodiments illustrated in FIGS. 3 to 6, which is not described in the embodiment of the invention.

FIG. 8 is a flowchart of an access method according to an embodiment of the invention, and the method in FIG. 8 is executed by a UE.

In 801, the UE sends a service request to a wireless controller of the UE.

In 802, the UE receives a service acceptance message sent by the wireless controller according to the service request.

The service acceptance message carries information about a serving base station. The serving base station is a candidate base station determined by the wireless controller from a set of candidate base stations of the UE based on a predetermined rule. The set of candidate base stations of the UE includes at least one candidate base station of the UE. The set of candidate base stations of the UE is determined by the wireless controller according to the service request.

In the embodiment of the invention, the UE sends a service request to the wireless controller to obtain information about the serving base station selected by the wireless controller from base stations of the UE based on a predetermined rule, so that the UE can flexibly choose a serving base station to access.

Optionally, the service request carries a service type of the UE; and determining the serving base station by the wireless controller based on the predetermined rule includes: the wireless controller determines the serving base station based on at least one of the following information: a quality of service (QoS) policy corresponding to the service type, channel quality information of the at least one candidate base station, resource usage information of the at least one candidate base station, link information of at least one transport network connected to the at least one candidate base station and a traffic control policy corresponding to the service type in the at least one transport network. In the embodiment of the invention, the wireless controller determines the serving base station based on transmission conditions of the candidate base station, which is to be accessed by the UE, at a user plane bearer side and a transport network side, so that the serving base station accessed by the UE can provide a high-quality service access path.

Optionally, in an embodiment, the service request further carries a base station standard supported by the UE and location information of the UE, which are used by the wireless controller to determine the set of candidate base stations of the UE based on the base station standard supported by the UE and the location information of the UE, where a distance between a location of the UE and a location of any candidate base station in the set of candidate base stations is smaller than a predetermined distance. In the embodiment of the invention, the base station standard supported by the UE and the location information of the UE is carried in the service request by the UE, and thus the range in which the wireless controller determines the candidate base station of the UE is narrowed.

Optionally, in another embodiment, the service request further carries a base station identity (ID), a public land mobile network (PLMN), carrier information and a base station standard of at least one base station. A base station standard of the at least one base station includes a base station standard supported by the UE. The wireless controller determines the at least one base station to be a candidate base station in the set of candidate base stations of the UE by using the base station identity (ID), the public land mobile network (PLMN), the carrier information and the base station standard of the at least one base station. In the embodiment of the invention, the candidate base station of the UE is carried in the service request by the UE, which narrows the range in which the wireless controller determines the candidate base station of the UE. In addition, the candidate base station of the UE is carried in the service request by the UE, which can reduce operation overhead of the wireless controller.

Optionally, in another embodiment, the service request further carries an identity ID of the UE, which is used by the wireless controller to obtain a base station standard supported by the UE and location information of the UE based on the ID of the UE and determine the set of candidate base stations based on the base station standard supported by the UE and location information of the UE, where a distance between a location of the UE and a location of any candidate base station in the set of candidate base stations is smaller than a predetermined distance. In the embodiment of the invention, the ID of the UE is carried in the service request by the UE, so that the wireless controller can obtain the base station standard supported by the UE and the location of the UE based on the ID of the UE and further select a candidate base station which can support the UE from base stations within a certain range around the UE, thereby reducing the range in which the wireless controller determines the serving base station of the UE. In addition, the service request carries only the ID of the UE, which to some degree reduces an occupation of an uplink bandwidth.

Optionally, the quality of service (QoS) policy corresponding to the service type includes a QoS policy obtained by the wireless controller from QoS policy information stored in the wireless controller; or the QoS policy corresponding to the service type includes a QoS policy obtained by the wireless controller from a policy and charging rules function PCRF entity of the UE. In the embodiment of the invention, a reference condition of the QoS policy corresponding to the service type is provided for the wireless controller to determine the serving base station of the UE.

Optionally, the channel quality information of the at least one candidate base station includes channel quality information extracted by the wireless controller from information carried in the service request of the UE; or the channel quality information of the at least one candidate base station includes channel quality information obtained by the wireless controller by querying the at least one candidate base station. In the embodiment of the invention, a reference condition of channel quality of the candidate base station is provided for the wireless controller to determine the serving base station of the UE.

Optionally, the resource usage information of the at least one candidate base station includes resource block (RB) usage information obtained by the wireless controller by querying the at least one candidate base station; or the resource usage information of the at least one candidate base station includes backhaul resource usage information obtained by the wireless controller by querying a transport network controller connected to the at least one candidate base station; or the resource usage information of the at least one candidate base station includes backhaul resource usage information obtained by the wireless controller by querying at least one packet data gateway (PGW) connected to the at least one candidate base station. In the embodiment of the invention, a reference condition of backhaul resource usage of the candidate base station is provided for the wireless controller to determine the serving base station of the UE.

Optionally, the link information of the at least one transport network connected to the at least one candidate base station includes transport network link information obtained by the wireless controller by querying a transport network controller of the at least one transport network connected to the at least one candidate base station; or the link information of the at least one transport network connected to the at least one candidate base station includes a transport network route delay obtained by the wireless controller by querying a border router of the at least one transport network connected to the at least one candidate base station; or the link information of at least one transport network connected to the at least one candidate base station includes egress bandwidth usage information obtained by the wireless controller by querying a transport network traffic controller of the at least one transport network connected to the at least one candidate base station. In the embodiment of the invention, a reference condition of link conditions of the transport network connected to the candidate base station is provided for the wireless controller to determine the serving base station of the UE.

Optionally, the traffic control policy corresponding to the service type in the at least one transport network includes a traffic control policy obtained by the wireless controller by querying a transport network controller of the at least one transport network connected to the at least one candidate base station; or the traffic control policy corresponding to the service type in the at least one transport network includes a traffic control policy obtained by the wireless controller by querying a transport network traffic controller of the at least one transport network connected to the at least one candidate base station. In the embodiment of the invention, a reference condition of the traffic control policy of the transport network connected to the candidate base station is provided for the wireless controller to determine the serving base station of the UE.

Reference can be made to the embodiments illustrated in FIGS. 4 to 6 for details of the method in the embodiment of the invention, which is not described in the embodiment of the invention.

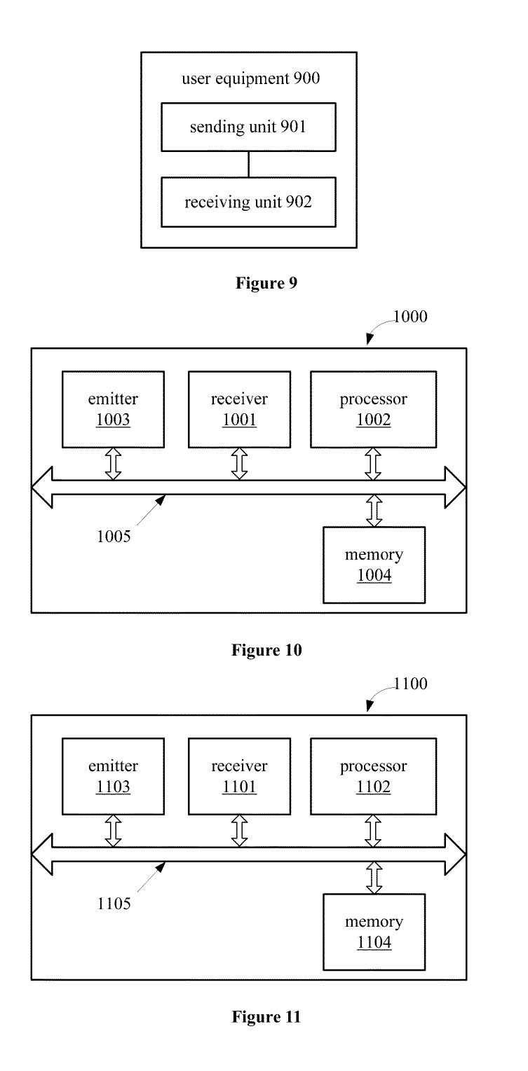

FIG. 9 is a structural schematic diagram of a user equipment 900 according to an embodiment of the invention. The user equipment 900 may include a sending unit 901 and a receiving unit 902.

The sending unit 901 is configured to send a service request to a wireless controller of the user equipment 900.

The receiving unit 902 is configured to receive a service acceptance message sent by the wireless controller according to the service request.

The service acceptance message carries information about a serving base station. The serving base station is a candidate base station determined by the wireless controller from a set of candidate base stations of the user equipment 900 based on a predetermined rule. The set of candidate base stations of the user equipment 900 includes at least one candidate base station of the user equipment 900. The set of candidate base stations of the user equipment 900 is determined by the wireless controller according to the service request.

In the embodiment of the invention, the user equipment 900 sends to the wireless controller a service request message to obtain information about the serving base station selected by the wireless controller from candidate base stations of the user equipment 900 based on a predetermined rule, so that the UE can flexibly choose a serving base station to access.

Optionally, the service request carries a service type of the user equipment 900, and the wireless controller determining the serving base station based on the predetermined rule includes the wireless controller determining the serving base station based on at least one of the following information: a quality of service (QoS) policy corresponding to the service type, channel quality information of the at least one candidate base station, resource usage information of the at least one candidate base station, link information of at least one transport network connected to the at least one candidate base station and a traffic control policy corresponding to the service type in the at least one transport network. In the embodiment of the invention, the wireless controller determines the serving base station based on transmission conditions of the candidate base station, which is to be accessed by the user equipment 900, at a user plane bearer side and a transport network side, so that the serving base station accessed by the user equipment 900 can provide a high-quality service access path.

Optionally, in an embodiment, the service request further carries a base station standard supported by the user equipment 900 and location information of the user equipment 900 which are used by the wireless controller to determine the set of candidate base stations of the user equipment 900 based on the base station standard supported by the user equipment 900 and the location information of the user equipment 900, where a distance between a location of the user equipment 900 and a location of any candidate base station in the set of candidate base stations of the user equipment 900 is smaller than a predetermined distance. In the embodiment of the invention, the base station standard supported by the user equipment 900 and the location information of the user equipment 900 are carried in the service request by the user equipment 900, thus the range in which the wireless controller determines the candidate base station of the user equipment 900 is narrowed.

Optionally, in another embodiment, the service request further carries a base station identity (ID), a public land mobile network (PLMN), carrier information and a base station standard of at least one base station. The base station standard of the at least one base station include a base station standard supported by the user equipment 900. The wireless controller determines the at least one base station to be a candidate base station in the set of candidate base stations of the user equipment 900 based on the base station identity (ID), the public land mobile network (PLMN), the carrier information and the base station standard of the at least one base station. In the embodiment of the invention, the candidate base station of the user equipment 900 is carried in the service request by the user equipment 900, which narrows the range in which the wireless controller determines the candidate base station of the user equipment 900. In addition, the candidate base station of the user equipment 900 is carried in the service request by the user equipment 900, which can reduce operation overhead of the wireless controller.

Optionally, in another embodiment, the service request carries an ID of the user equipment 900, which is used for the wireless controller to obtain a base station standard supported by the user equipment 900 and location information of the user equipment 900 based on the ID of the user equipment 900 and determine the set of candidate base stations based on the base station standard supported by the user equipment 900 and the location information of the user equipment 900, where a distance between a location of the user equipment 900 and a location of any candidate base station in the set of candidate base stations is smaller than a predetermined distance. In the embodiment of the invention, the ID of the user equipment 900 is carried in the service request by the user equipment 900, so that the wireless controller can obtain the base station standard supported by the user equipment 900 and the location of the user equipment 900 based on the ID of the user equipment 900 and then select a candidate base station which can support the user equipment 900 from base stations within a certain range around the user equipment 900, thereby reducing the range in which the wireless controller determines the serving base station of the user equipment 900. In addition, the service request carries only the ID of the user equipment 900, which to same degree reduces an occupation of an uplink bandwidth.

Optionally, the quality of service (QoS) policy corresponding to the service type includes a QoS policy obtained by the wireless controller from QoS policy information stored in the wireless controller; or the QoS policy corresponding to the service type includes a QoS policy obtained by the wireless controller from a policy and charging rules function PCRF entity of the user equipment 900. In the embodiment of the invention, a reference condition of the QoS policy corresponding to the service type is provided for the wireless controller to determine the serving base station of the user equipment 900.

Optionally, the channel quality information of the at least one candidate base station includes channel quality information extracted by the wireless controller from information carried in the service request of the user equipment 900; or the channel quality information of the at least one candidate base station includes channel quality information obtained by the wireless controller by querying the at least one candidate base station. In the embodiment of the invention, a reference condition of channel quality of the candidate base station is provided for the wireless controller to determine the serving base station of the user equipment 900.

Optionally, the resource usage information of the at least one candidate base station includes resource block (RB) usage information obtained by the wireless controller by querying the at least one candidate base station; or the resource usage information of the at least one candidate base station includes backhaul resource usage information obtained by the wireless controller by querying a transport network controller connected to the at least one candidate base station; or the resource usage information of the at least one candidate base station includes backhaul resource usage information obtained by the wireless controller by querying at least one packet data gateway (PGW) connected to the at least one candidate base station. In the embodiment of the invention, a reference condition of backhaul resource usage of the candidate base station is provided for the wireless controller to determine the serving base station of the user equipment 900.

Optionally, the link information of the at least one transport network connected to the at least one candidate base station includes transport network link information obtained by the wireless controller by querying a transport network controller of the at least one transport network connected to the at least one candidate base station; or the link information of the at least one transport network connected to the at least one candidate base station includes a transport network route delay obtained by the wireless controller by querying a border router of the at least one transport network connected to the at least one candidate base station; or the link information of the at least one transport network connected to the at least one candidate base station includes egress bandwidth usage information obtained by the wireless controller by querying a transport network traffic controller of the at least one transport network connected to the at least one candidate base station. In the embodiment of the invention, a reference condition of link conditions of the transport network connected to the candidate base station is provided for the wireless controller to determine the serving base station of the user equipment 900.

Optionally, the traffic control policy corresponding to the service type in the at least one transport network includes a traffic control policy obtained by the wireless controller by querying a transport network controller of the at least one transport network connected to the at least one candidate base station; or the traffic control policy corresponding to the service type in the at least one transport network includes a traffic control policy obtained by the wireless controller by querying a transport network traffic controller of the at least one transport network connected to the at least one candidate base station. In the embodiment of the invention, a reference condition of the traffic control policy of the transport network connected to the candidate base station is provided for the wireless controller to determine the serving base station of the user equipment 900.

Reference can be made to the embodiments illustrated in FIGS. 4 to 6 for details of the method in the embodiment of the invention, which is not described in the embodiment of the invention.

In addition, the user equipment 900 can perform the method in FIG. 8, and has the functions of the UE in the embodiments illustrated in FIGS. 4 to 6. The implementations thereof can refer to the embodiments illustrated in FIGS. 4 to 6 and FIG. 8, which is not described in the embodiment of the invention.

FIG. 10 is a structural schematic diagram of a wireless controller 1000 according to an embodiment of the invention. The wireless controller 1000 may include a receiver 1001, an emitter 1003, a processor 1002 and a memory 1004.

The receiver 1001, the emitter 1003, the processor 1002 and the memory 1004 are connected to each other through a bus 1005. The bus 1005 may be an ISA bus, a PCI bus or an EISA bus. The bus may include an address bus, a data bus and a control bus. For ease of illustration, the bus is represented by a bidirectional arrow in FIG. 10, which does not indicate that there is only one bus or only one type of bus.

The memory 1004 is configured to store a program. The program may include program codes, where the program codes include computer operation instructions. The memory 1004 may include a read-only memory and a random access memory, and may provide instructions and data to the processor 1002. The memory 1004 may include a high-speed RAM, and may further include a non-volatile memory (non-volatile memory) such as at least one disk memory.

The receiver 1001 is configured to receive a service request of a user equipment UE.

The emitter 1003 is configured to send a service acceptance message to the UE.

The processor 1002 is configured to execute the program stored in the memory 1004, to determine a set of candidate base stations of the UE according to the service request received by the receiver 1001, determine a serving base station based on a predetermined rule, and send, by the emitter 1003, the service acceptance message for the service request to the UE.

The set of candidate base stations includes at least one candidate base station. A base station standard of any candidate base station in the set of candidate base stations include a base station standard supported by the UE. The serving base station is one of the at least one candidate base station.

The method performed by the wireless controller disclosed in any one of the embodiments of the invention illustrated in FIGS. 3 to 6 may be applicable to the processor 1002 or may be implemented by the processor 1002. The processor 1002 may be an integrated circuit chip with a signal processing capability. In an implementation, the steps of the above method may be implemented by a hardware integrated logic circuit or instructions in a form of software in the processor 1002. The processor 1002 described above may be a general-purpose processor which includes a central processing unit (CPU) and a network processor (NP); or may be a digital signal processor (DSP), an application specific integrated circuit (ASIC), a field programmable gate array (FPGA) or other programmable logic device, discrete gate or transistor logic device, discrete hardware component, which can implement or execute the methods, steps and logic blocks disclosed in the embodiments of the invention. The general-purpose processor may be a microprocessor or any conventional process. The steps of the method disclosed in the embodiment of the invention may be directly implemented by a hardware decoding processor, or by a combination of a hardware module and a software module of a decoding processor. The software module may be in a mature storage medium in the art, such as a random access memory, a flash memory, a read-only memory, a programmable read-only memory, an electrically erasable programmable memory and a register. The storage medium is in the memory 1004, and the processor 1002 reads information in the memory 1004 and performs the steps of the above method with the hardware of the processor.

In the embodiment of the invention, the wireless controller 1000 determines at least one candidate base station of the UE and determines a serving base station of the UE from the at least one candidate base station based on a predetermined rule, so that the wireless controller can flexibly provide a serving base station for the UE to access.

It should be noted that the wireless controller 1000 according to the embodiment of the invention is applicable to not only the network architecture with control and bearer separated in FIG. 2, but also the network architecture illustrated in FIG. 1, including but not limited to a network architecture of an LTE system.

In the embodiment of the invention, the predetermined rule may be a selection policy specified by an operator, a selection policy determined based on a certain standard or other selection policy configured artificially.

The service request carries a service type of the UE; and the processor 1002, for determining the serving base station based on the predetermined rule, is configured to determine the serving base station based on at least one of the following information: a quality of service (QoS) policy corresponding to the service type, channel quality information of the at least one candidate base station, resource usage information of the at least one candidate base station, link information of at least one transport network connected to the at least one candidate base station and a traffic control policy corresponding to the service type in the at least one transport network. Based on the selection conditions described above, the wireless controller can select an appropriate base station from the at least one candidate base station in the set of candidate base stations to serve as the serving base station of the UE. In the embodiment of the invention, based on transmission conditions of the candidate base station, which is to be accessed by the UE, at a user plane bearer side and a transport network side, a serving base station with a good comprehensive transmission condition is selected by the wireless controller 1000 from the candidate base stations of the UE, thereby establishing a high-quality service access path for the UE.

Optionally, the processor 1002 may be further configured to obtain at least one of the following information: the quality of service (QoS) policy corresponding to the service type, the channel quality information of the at least one candidate base station, the resource usage information of the at least one candidate base station, the link information of at least one transport network connected to the at least one candidate base station and the traffic control policy corresponding to the service type in the at least one transport network. In the embodiment of the invention, transmission conditions of the base station at a user plane bearer side and a transport network side are obtained by the wireless controller 1000, which provides a selection condition for the wireless controller to determine a high-quality serving base station of the UE.

Optionally, in an embodiment, the service request carries a base station standard supported by the UE and location information of the UE; and the processor 1002, for determining the set of candidate base stations of the UE according to the service request, is configured to determine the set of candidate base stations based on the base station standard supported by the UE and the location information of the UE. A distance between a location of the UE and a location of any candidate base station in the set of candidate base stations is smaller than a predetermined distance. The predetermined distance may be specified by a protocol or an operator, or specified artificially otherwise, which is not limited in the embodiment of the invention. In the embodiment of the invention, based on the base station standard supported by the UE and the location of the UE, a candidate base station which can support the UE is selected by the wireless controller 1000 from base stations within a certain range around the UE, thus the range in which the wireless controller determines the serving base station of the UE is narrowed. In addition, the service request carries the base station standard supported by the UE, so that the wireless controller does not need to store information about the base station standard supported by the UE, thereby reducing storage overhead of the wireless controller 1000.

Furthermore, the processor 1002, for obtaining the channel quality information of the at least one candidate base station, is configured to: send, by the emitter 1003, information about the at least one candidate base station to the UE, where the information about the at least one candidate base station includes a base station identity (ID), a public land mobile network (PLMN), carrier information and a base station standard of the at least one candidate base station; and receive, by the receiver 1001, the channel quality information of the at least one candidate base station measured by the UE. In the embodiment of the invention, the wireless controller 1000 may obtain the channel quality information of each candidate base station by querying the candidate base stations for the channel quality information respectively, thereby providing a reference condition of channel quality for the wireless controller 1000 to determine the serving base station of the UE.

Optionally, in another embodiment, the service request carries an ID of the UE; and the processor 1002 is further configured to obtain a base station standard supported by the UE and location information of the UE based on the ID of the UE; and the processor 1002, for determining the set of candidate base stations of the UE according to the service request, is configured to determine the set of candidate base stations based on the base station standard supported by the UE and the location information of the UE, where a distance between a location of the UE and a location of any candidate base station in the set of candidate base stations is smaller than a predetermined distance. In the embodiment of the invention, the base station standard supported by the UE and the location of the UE are obtained by the wireless controller 1000 based on the ID of the UE, so that a candidate base station which can support the UE can be selected from base stations within a certain range around the UE, and thus the range in which the wireless controller 1000 determines the serving base station of the UE is narrowed. In addition, the service request carries only the ID of the UE, which to some degree reduces an occupation of an uplink bandwidth.

Furthermore, the processor 1002, for obtaining the channel quality information of the at least one candidate base station, is configured to: send, by the emitter 1003, information about the at least one candidate base station to the UE, where the information about the at least one candidate base station includes a base station (ID), a public land mobile network (PLMN), carrier information and a base station standard of the at least one candidate base station; and receive, by the receiver 1001, channel quality information of the at least one candidate base station measured by the UE. In the embodiment of the invention, the wireless controller 1000 may obtain the channel quality information of each candidate base station by querying the candidate base stations for the channel quality information respectively, thereby providing a reference condition of channel quality for the wireless controller 1000 to determine the serving base station of the UE.

Optionally, in another embodiment, the service request carries a base station identity (ID), a public land mobile network (PLMN), carrier information and a base station standard of at least one base station, where the base station standard of the at least one base station include a base station standard supported by the UE; and the processor 1002, for determining the set of candidate base stations according to the service request, is configured to determine the at least one base station to be a candidate base station in the set of candidate base stations according to the service request. In the embodiment of the invention, the UE obtains information such as the candidate base station of the UE based on the base station standard supported by the UE, which narrows the range in which the wireless controller 1000 determines the serving base station of the UE. In addition, information about the candidate base station is carried in the service request by the UE, so that the wireless controller 1000 does not need to calculate for the candidate base station of the UE, thereby reducing operation overhead of the wireless controller.

Furthermore, the service request further carries channel quality information of the at least one base station; and the processor 1002, for obtaining the channel quality information of the at least one candidate base station, is configured to obtain the channel quality information of the at least one candidate base station from the service request. In the embodiment of the invention, the UE directly measures the channel quality information of the candidate base station and sends the measured channel quality information to the wireless controller, which provides a reference condition of channel quality for the wireless controller 1000 to determine the serving base station of the UE. In addition, the UE directly measures the channel quality information of the candidate base station and sends the measured channel quality information to the wireless controller 1000, which may reduce steps of querying for and obtaining the channel quality of the candidate base station by the wireless controller 1000, and to some degree reduce a response delay after the UE sends the request.

Optionally, in an embodiment, the processor 1002, for obtaining the QoS policy corresponding to the service type of the UE, is configured to: send, by the emitter 1003, a QoS policy query request to a policy and charging rules function (PCRF) entity of the UE, where the QoS policy query request is configured to request querying for a QoS policy of the UE in the PCRF. The Qos policy query request carries the service type of the UE; and receive, by the receiver 1001, information about the QoS policy corresponding to the service type of the UE sent by the PCRF. In the embodiment of the invention, the QoS policy corresponding to the service type of the UE is obtained by the wireless controller 1000, which provides a reference condition of the QoS policy for the wireless controller 1000 to determine the serving base station of the UE. In addition, the QoS policy corresponding to the service type of the UE is obtained from Qos policies stored in the wireless controller 1000, which may improve obtaining the QoS policy and to some degree reduce a response delay after the UE sends the request.

Optionally, in another embodiment, the processor 1002, for obtaining the QoS policy corresponding to the service type of the UE, is configured to obtain the QoS policy corresponding to the service type of the UE from QoS policies stored in the wireless controller 1000. In the embodiment of the invention, the wireless controller 1000 obtains the QoS policy corresponding to the service type of the UE from PCRF, which provides a reference condition of the QoS policy for the wireless controller 1000 to determine the serving base station of the UE. In addition, the QoS policy corresponding to the service type of the UE is obtained from the PCRF by the wireless controller 1000, which may obtain a real-time Qos policy corresponding to the service type of the UE.

Optionally, in an embodiment, the processor 1002, for obtaining the resource usage information of the at least one candidate base station, is configured to: send, by the emitter 1003, a resource block (RB) query message to a candidate base station of the at least one candidate base station, where the RB query message is configured to query for RB usage information of the candidate base station of the at least one candidate base station; and receive, by the receiver 1001, the RB usage information sent by the candidate base station of the at least one candidate base station. In the embodiment of the invention, the wireless controller 1000 obtains the RB usage information of the candidate base station, which provides a reference condition of RB usage for the wireless controller 1000 to determine the serving base station of the UE.

Optionally, in an embodiment, the processor 1002, for obtaining the resource usage information of the at least one candidate base station, is configured to: send, by the emitter 1003, a backhaul resource query message to a transport network controller of at least one transport network connected to the at least one candidate base station, where the backhaul resource query message is configured to query for the backhaul resource usage information of the at least one candidate base station; and receive, by the receiver 1001, the backhaul resource usage information of the at least one candidate base station sent by the transport network controller. In the embodiment of the invention, the backhaul resource usage information of the candidate base station is obtained the wireless controller 1000, which provides a reference condition of backhaul resource usage for the wireless controller 1000 to determine the serving base station of the UE.

Optionally, in an embodiment, the processor 1002, for obtaining the resource usage information of the at least one candidate base station, is configured to: send, by the emitter 1003, a backhaul resource query message to at least one packet data gateway (PGW) connected to the at least one candidate base station, where the backhaul resource query message is configured to query for the backhaul resource usage information of the at least one candidate base station; and receive, by the receiver 1001, the backhaul resource usage information of the at least one candidate base station sent by the at least one PGW. In the embodiment of the invention, the backhaul resource usage information of the candidate base station is obtained by the wireless controller 1000, which provides a reference condition of backhaul resource usage for the wireless controller 1000 to determine the serving base station of the UE.

Optionally, in an embodiment, the processor 1002, for obtaining the link information of at least one transport network connected to the at least one candidate base station, is configured to: send, by the emitter 1003, a link query message to a transport network controller of the at least one transport network connected to the at least one candidate base station, where the link query message is configured to query for the link information of the at least one transport network connected to the at least one candidate base station; and receive, by the receiver 1001, the link information of the at least one transport network connected to the at least one candidate base station sent by the transport network controller, where the link information includes a transport network route delay and/or egress bandwidth usage information of the at least one transport network. In the embodiment of the invention, the link information of the transport network connected to the candidate base station is obtained by the wireless controller 1000, which provides a reference condition of the transport network link for the wireless controller 1000 to determine the serving base station of the UE.

Optionally, in an embodiment, the processor 1002, for obtaining the link information of at least one transport network connected to the at least one candidate base station, is configured to: send, by the emitter 1003, a route delay query message to a transport network border router of the at least one transport network connected to the at least one candidate base station, where the route delay query message is configured to query for a transport network route delay of the at least one transport network; and receive, by the receiver 1001, the transport network route delay of the at least one transport network sent by the transport network border router. In the embodiment of the invention, the link delay information of the transport network connected to the candidate base station is obtained by the wireless controller 1000, which provides a reference condition of the transport network route delay for the wireless controller 1000 to determine the serving base station of the UE.

Optionally, in an embodiment, the processor 1002, for obtaining the link information of at least one transport network connected to the at least one candidate base station, is configured to: send, by the emitter 1003, an egress bandwidth query message to a transport network traffic controller of the at least one transport network connected to the at least one candidate base station, where the egress bandwidth query message is configured to query for egress bandwidth usage information of the at least one transport network; and receive, by the receiver 1001, the egress bandwidth usage information of the at least one transport network sent by the transport network traffic controller. In the embodiment of the invention, the link egress bandwidth usage information of the transport network connected to the candidate base station is obtained by the wireless controller 1000, which provides a reference condition of link egress network usage of the transport network for the wireless controller 1000 to determine the serving base station of the UE.

Optionally, in an embodiment, the processor 1002, for obtaining the traffic control policy corresponding to the service type in the at least one transport network, is configured to: send, by the emitter 1003, a traffic control policy query message to a transport network controller of the at least one transport network connected to the at least one candidate base station, where the traffic control policy query message is configured to query for the traffic control policy of the at least one transport network; and receive, by the receiver 1001, the traffic control policy of the at least one transport network sent by the transport network controller. In the embodiment of the invention, the traffic control policy of the transport network connected to the candidate base station is obtained by the wireless controller 1000 from the transport network controller of the transport network, which provides a reference condition of the transport network traffic control policy for the wireless controller 1000 to determine the serving base station of the UE.

Optionally, in an embodiment, the processor 1002, for obtaining the traffic control policy corresponding to the service type in the at least one transport network, is configured to: send, by the emitter 1003, a traffic control policy query message to a transport network traffic controller of the at least one transport network connected to the at least one candidate base station, where the traffic control policy query message is configured to query for the traffic control policy of the at least one transport network; and receive, by the receiver 1001, the traffic control policy of the at least one transport network sent by the transport network traffic controller. In the embodiment of the invention, link egress bandwidth usage information of the service type of the UE in the transport network connected to the candidate base station is obtained by the wireless controller 1000 from the transport network traffic controller of the transport network, which provides a reference condition of link egress bandwidth usage of the transport network for the wireless controller 1000 to determine the serving base station of the UE.

Optionally, the information about the serving base station includes an ID, a base station standard, carrier information and PLMN information of the serving base station.

In addition, the wireless controller 1000 may perform the method in FIG. 3, and has the functions of the wireless controller in the embodiments illustrated in FIGS. 4 to 6, and the implementations thereof may refer to the embodiments illustrated in FIGS. 3 to 6, which is not described in the embodiment of the invention.

FIG. 11 is a structural schematic diagram of a user equipment 1100 according to an embodiment of the invention. The user equipment 1100 may include a receiver 1101, an emitter 1103, a processor 1102 and a memory 1104.

The receiver 1101, the emitter 1103, the processor 1102 and the memory 1104 are connected to each other through a bus 1105. The bus 1105 may be an ISA bus, a PCI bus or an EISA bus. The bus may include an address bus, a data bus and a control bus. For ease of illustration, the bus is represented by a bidirectional arrow in FIG. 11, which does not indicate that there is only one bus or only one type of bus.

The memory 1104 is configured to store a program. The program may include program codes. The program codes include computer operation instructions. The memory 1104 may include a read-only memory and a random access memory, and provides instructions and data to the processor 1102. The memory 1104 may include a high-speed RAM, and may further include a non-volatile memory (non-volatile memory) such as at least one disk memory.

The emitter 1103 is configured to send a service request to a wireless network controller corresponding to the user equipment 1100.

The receiver 1101 is configured to receive a service acceptance message sent by the wireless controller according to the service request.

The service acceptance message carries information about a serving base station. The serving base station a candidate base station determined by the wireless controller from a set of candidate base stations of the user equipment 1100 based on a predetermined rule. The set of candidate base stations of the user equipment 1100 includes at least one candidate base station of the user equipment 1100. The set of candidate base stations of the user equipment 1100 is determined by the wireless controller according to the service request.

The processor 1102 is configured to execute the program stored in the memory 1104, to send, by the emitter 1103, the service request to the wireless controller of the user equipment 1100 and receive, by the receiver 1101, the service acceptance message sent by the wireless controller according to the service request.

The method which is performed by the UE disclosed in any one of the embodiments of the invention illustrated in FIGS. 4 to 6 and FIG. 8 is applicable to the processor 1102, or implemented by the processor 1102. The processor 1102 may be an integrated circuit chip with a signal processing capability. In an implementation, the steps of the above method may be performed by a hardware integrated logic circuit or instructions in a form of software in the processor 1102. The processor 1102 described above may be a general-purpose processor which includes a central processing unit (CPU) and a network processor (NP); or may be a digital signal processor (DSP), an application specific integrated circuit (ASIC), a field programmable gate array (FPGA) or other programmable logic device, discrete gate or transistor logic device, discrete hardware component, which can implement or execute the methods, steps and logic blocks disclosed in the embodiments of the invention. The general-purpose processor may be a microprocessor or any conventional process. The steps of the method disclosed in the embodiment of the invention may be directly implemented by a hardware decoding processor, or by a combination of a hardware module and a software module of a decoding processor. The software module may be in a mature storage medium in the art, such as a random access memory, a flash memory, a read-only memory, a programmable read-only memory, an electrically erasable programmable memory and a register. The storage medium is in the memory 1104, and the processor 1102 reads information in the memory 1004 and implements the steps of the above method with the hardware of the processor.

In the embodiment of the invention, the user equipment 1100 sends the service request message to the wireless controller to obtain information about the serving base station selected by the wireless controller from base stations of the user equipment 1100 based on the predetermined rule, so that the UE can flexibly choose a serving base station to access.

Optionally, the service request carries a service type of the user equipment 1100, and the wireless controller determining the serving base station based on the predetermined rule includes the wireless controller determining the serving base station based on at least one of the following information: a quality of service (QoS) policy corresponding to the service type, channel quality information of the at least one candidate base station, resource usage information of the at least one candidate base station, link information of at least one transport network connected to the at least one candidate base station and a traffic control policy corresponding to the service type in the at least one transport network. In the embodiment of the invention, the wireless controller determines the serving base station based on transmission conditions of the candidate base station, which is to be accessed by the user equipment 1100, at a user plane bearer side and a transport network side, so that the serving base station accessed by the user equipment 1100 can provide a high-quality service access path.

Optionally, in an embodiment, the service request further carries a base station standard supported by the user equipment 1100 and location information of the user equipment 1100, which are used by the wireless controller to determine the set of candidate base stations of the user equipment 1100 based on the base station standard supported by the user equipment 1100 and the location information of the user equipment 1100, where a distance between a location of the user equipment 1100 and a location of any candidate base station in the set of candidate base stations of the user equipment 1100 is smaller than a predetermined distance. In the embodiment of the invention, the base station standard supported by the user equipment 1100 and the location information of the user equipment 1100 are carried in the service request by the user equipment 1100, thus the range in which the wireless controller determines the serving base station of the user equipment 1100 is narrowed.

Optionally, in another embodiment, the service request further carries a base station identity (ID), a public land mobile network (PLMN), carrier information and a base station standard of at least one base station. The base station standard of the at least one base station includes a base station standard supported by the user equipment 1100. The wireless controller determines the at least one base station to be a candidate base station in the set of candidate base stations of the user equipment 1100 based on the base station identity (ID), the public land mobile network (PLMN), the carrier information and the base station standard of the at least one base station. In the embodiment of the invention, the candidate base station of the user equipment 1100 is carried in the service request of the user equipment 1100, which narrows the range in which the wireless controller determines a candidate base station of the user equipment 1100. In addition, the candidate base station of the user equipment 1100 is carried in the service request of the user equipment 1100, which reduces operation overhead of the wireless controller.

Optionally, in another embodiment, the service request further carries an ID of the user equipment 1100, which is used by the wireless controller to obtain a base station standard supported by the user equipment 1100 and location information of the user equipment 1100 based on the ID of the user equipment 1100 and determine the set of candidate base stations based on the base station standard supported by the user equipment 1100 and the location information of the user equipment 1100, where a distance between a location of the user equipment 1100 and a location of any candidate base station in the set of candidate base stations is smaller than a predetermined distance. In the embodiment of the invention, the ID of the user equipment 1100 is carried in the service request by the user equipment 1100, so that the wireless controller can obtain the base station standard supported by the user equipment 1100 and the location of the user equipment 1100 based on the ID of the user equipment 1100 and then select a candidate base station which can support the user equipment 1100 from base stations within a certain range around the user equipment 1100, thus the range in which the wireless controller determines the serving base station of the user equipment 1100 is narrowed. In addition, the service request carries only the ID of the user equipment 1100, which to some degree reduces an occupation of an uplink bandwidth.

Optionally, the quality of service (QoS) policy corresponding to the service type includes a QoS policy obtained by the wireless controller from QoS policy information stored in the wireless controller; or the QoS policy corresponding to the service type includes a QoS policy obtained by the wireless controller from a policy and charging rules function PCRF entity of the user equipment 1100. In the embodiment of the invention, a reference condition of the QoS policy corresponding to the service type is provided for the wireless controller to determine the serving base station of the user equipment 1100.

Optionally, the channel quality information of the at least one candidate base station includes channel quality information extracted by the wireless controller from information carried in the service request of the user equipment 1100; or the channel quality information of the at least one candidate base station includes channel quality information obtained by the wireless controller by querying the at least one candidate base station. In the embodiment of the invention, a reference condition of channel quality of the candidate base station is provided for the wireless controller to determine the serving base station of the user equipment 1100.

Optionally, the resource usage information of the at least one candidate base station includes resource block (RB) usage information obtained by the wireless controller by querying the at least one candidate base station; the resource usage information of the at least one candidate base station includes backhaul resource usage information obtained by the wireless controller by querying a transport network controller connected to the at least one candidate base station; or the resource usage information of the at least one candidate base station includes backhaul resource usage message obtained by the wireless controller by querying at least one packet data gateway (PGW) connected to the at least one candidate base station. In the embodiment of the invention, a reference condition of backhaul resource usage of the candidate base station is provided for the wireless controller to determine the serving base station of the user equipment 1100.

Optionally, the link information of the at least one transport network connected to the at least one candidate base station includes transport network link information obtained by the wireless controller by querying a transport network controller of the at least one transport network connected to the at least one candidate base station; or the link information of the at least one transport network connected to the at least one candidate base station includes a transport network route delay obtained by the wireless controller by querying a border router of the at least one transport network connected to the at least one candidate base station; or the link information of the at least one transport network connected to the at least one candidate base station includes egress bandwidth usage information obtained by the wireless controller by querying a transport network traffic controller of the at least one transport network connected to the at least one candidate base station. In the embodiment of the invention, a reference condition of link conditions of the transport network connected to the candidate base station is provided for the wireless controller to determine the serving base station of the user equipment 1100.

Optionally, the traffic control policy corresponding to the service type in the at least one transport network includes a traffic control policy obtained by the wireless controller by querying a transport network controller of the at least one transport network connected to the at least one candidate base station; or the traffic control policy corresponding to the service type in the at least one transport network includes a traffic control policy obtained by the wireless controller by querying a transport network traffic controller of the at least one transport network connected to the at least one candidate base station. In the embodiment of the invention, a reference condition of the traffic control policy of the transport network connected to the candidate base station is provided for the wireless controller to determine the serving base station of the user equipment 1100.

In addition, the user equipment 1100 may execute the method in FIG. 8, and has the functions of the UE in the embodiments illustrated in FIGS. 4 to 6, and the implementations thereof may refer to the embodiments illustrated in FIGS. 4 to 6 and FIG. 8, which is not described in the embodiment of the invention.

Those skilled in the art should understand that various illustrative units and algorithm steps described in connection with the embodiments herein may be implemented by electronic hardware or a combination of computer software and electronic hardware. Whether such functionality is implemented by hardware or software depends on particular application and design constraints of the technical solution. Those skilled in the art can implement the described functionality in varying ways for each particular application, and such implementation should not be interpreted as going beyond the scope of the present invention.

Those skilled in the art should understand that, for ease and simplicity of description, the operational details of the systems, devices and units described above may refer to corresponding processes in the foregoing method embodiments, which are not described herein anymore.

It should be understood that the systems, devices and methods disclosed in the embodiments of the present application may be implemented in other manners. For example, the device embodiments described above are only illustrative. For example, the partition of the units is only a logic functional partition, and there may be other partition manners in practice. For example, multiple units or components may be combined or integrated into another system, or some features may be omitted or not performed. In addition, the couple or direct couple or communication connection with each other may be indirect couple or communication connection between interfaces, device or units, and may be implemented electrically, mechanically or in other manner.

The units described as separate components may be or not be separated physically, and a component illustrated as a unit may be or not be a physical unit, i.e., the component may be at one place, or distributed in multiple network units. A few or all of the units may be chosen based on practical needs to achieve the object of the technical solution of the embodiment.

In addition, the functional units according to the embodiment of the invention may be integrated into one processing unit or separated physically. Two or more of the units may be integrated into one unit.

When being implemented in the form of software functional units and sold or used as an independent product, the functionality may be stored in a computer readable storage medium. Based on such understanding, the essential part of the technical solution of the present invention, or the part of the technical solution of the present invention contributing to the prior art, or a part of the technical solution may be implemented in the form of a software product. The computer software product is stored in a storage medium including several instructions for instructing a computer device (which may be a personal computer, a server, or a network device) to perform all or a few of steps of the methods described in the embodiments of the invention. The foregoing storage medium includes a medium that can store program codes, such as a USB flash disk, a mobile hard disk, a read-only memory (ROM), a random access memory (RAM), a magnetic disk and an optical disk.

Described above are only some particular embodiments of the invention, and the scope of protection of the invention is not limited to thereto. Various changes and substitutions apparent to those of skill in the art within the technical scope of the present invention shall fall within the scope of protection of the invention. Therefore, the scope of protection of the invention is to be construed in accordance with the protection scope defined by the claims.

What is claimed is:

1. A service access method, comprising:
receiving a service request of a user equipment (UE);
determining a set of candidate base stations of the UE according to the service request, wherein the set of candidate base stations comprises at least one candidate base station, and a base station standard of any candidate base station in the set of candidate base stations comprises a base station standard supported by the UE;
determining a serving base station based on a predetermined rule, wherein the serving base station is one of the at least one candidate base station; and
sending a service acceptance message for the service request to the UE, wherein the service acceptance message carries information about the serving base station.

2. The method according to claim 1, wherein,
the service request carries a service type of the UE, and determining the serving base station based on the predetermined rule comprises:
determining the serving base station based on at least one of following information: a quality of service (QoS) policy corresponding to the service type, channel quality information of the at least one candidate base station, resource usage information of the at least one candidate base station, link information of at least one transport network connected to the at least one candidate base station and a traffic control policy corresponding to the service type in the at least one transport network.

3. The method according to claim 2, wherein, before determining the serving base station based on the predetermined rule, the method further comprises:
obtaining at least one of following information: the quality of service (QoS) policy corresponding to the service type, the channel quality information of the at least one candidate base station, the resource usage information of the at least one candidate base station, the link information of the at least one transport network connected to the at least one candidate base station and the traffic control policy corresponding to the service type in the at least one transport network.

4. The method according to claim 3, wherein,
the service request carries the base station standard supported by the UE and location information of the UE, and determining the set of candidate base stations of the UE according to the service request comprises determining the set of candidate base stations based on the base station standard supported by the UE and the location information of the UE, wherein a distance between a location of the UE and a location of any candidate base station in the set of candidate base stations is smaller than a predetermined distance.

5. The method according to claim 3, wherein,
the service request carries an ID of the UE, and determining the set of candidate base stations of the UE according to the service request comprises:
obtaining the base station standard supported by the UE and location information of the UE based on the ID of the UE; and
determining the set of candidate base stations based on the base station standard supported by the UE and the location information of the UE, wherein a distance between a location of the UE and a location of any candidate base station in set of the candidate base stations is smaller than a predetermined distance.

6. The method according to claim 3, wherein,
the service request carries a base station identity (ID), a public land mobile network (PLMN), carrier information and a base station standard of at least one base station, wherein the base station standard of the at least one base station comprises the base station standard supported by the UE, and determining the set of candidate base stations of the UE according to the service request comprises determining the at least one base station to be a candidate base station in the set of candidate base stations according to the service request.

7. The method according to claim 4, wherein obtaining the channel quality information of the at least one candidate base station comprises:
sending information about the at least one candidate base station to the UE, wherein the information about the at least one candidate base station comprises a base station identity (ID), a public land mobile network (PLMN), carrier information and a base station standard of the at least one candidate base station; and
receiving the channel quality information of the at least one candidate base station measured by the UE.

8. The method according to claim 3, wherein obtaining the QoS policy corresponding to the service type of the UE comprises:
sending a QoS policy query request to a policy and charging rules function (PCRF) entity of the UE, wherein the QoS policy query request is configured to request querying for the QoS policy of the UE in the PCRF, and the QoS policy query request carries the service type of the UE; and
receiving information about the QoS policy corresponding to the service type of the UE sent by the PCRF.

9. The method according to claim 3, wherein obtaining the resource usage information of the at least one candidate base station comprises:
sending a resource block (RB) query message to a candidate base station of the at least one candidate base station, wherein the RB query message is configured to query for RB usage information of the candidate base station of the at least one candidate base station, and the RB usage information of the candidate base station is one of the resource usage information of the candidate base station; and
receiving the RB usage information sent by the candidate base station of the at least one candidate base station.

10. The method according to claim 3, wherein obtaining the link information of the at least one transport network connected to the at least one candidate base station comprises:
sending a link query message to a transport network controller of the at least one transport network connected to the at least one candidate base station, wherein the link query message is configured to query for the link information of the at least one transport network connected to the at least one candidate base station; and
receiving the link information of the at least one transport network connected to the at least one candidate base station sent by the transport network controller, wherein the link information comprises a transport network route delay and/or egress bandwidth usage information of the at least one transport network.

11. The method according to claim 3, wherein obtaining the traffic control policy corresponding to the service type in the at least one transport network comprises:
sending a traffic control policy query message to a transport network controller of the at least one transport network connected to the at least one candidate base station, wherein the traffic control policy query message is configured to query for the traffic control policy of the at least one transport network; and
receiving the traffic control policy of the at least one transport network sent by the transport network controller.

12. A wireless controller, comprising:
a receiving unit, configured to receive a service request of a user equipment (UE);
a determination unit, configured to determine a set of candidate base stations of the UE according to the service request, wherein the set of candidate base stations comprises at least one candidate base station, and a base station standard of any candidate base station in the set of candidate base stations comprises a base station standard supported by the UE,
wherein the determination unit is further configured to determine a serving base station based on a predetermined rule, wherein the serving base station is one of the at least one candidate base station; and
a sending unit, configured to send a service acceptance message for the service request to the UE, wherein the service acceptance message carries information about the serving base station.

13. The wireless controller according to claim 12, wherein the service request carries a service type of the UE, and the determination unit, for determining the serving base station based on the predetermined rule, is configured to determine the serving base station based on at least one of follows: a quality of service (QoS) policy corresponding to the service type, channel quality information of the at least one candidate base station, resource usage information of the at least one candidate base station, link information of at least one transport network connected to the at least one candidate base station and a traffic control policy corresponding to the service type in the at least one transport network.

14. The wireless controller according to claim 13, further comprising an obtaining unit configured to obtain at least one of following information: the quality of service (QoS) policy corresponding to the service type, the channel quality information of the at least one candidate base station, the resource usage information of the at least one candidate base station, the link information of at least one transport network connected to the at least one candidate base station and the traffic control policy corresponding to the service type in the at least one transport network.

15. The wireless controller according to claim 14, wherein the service request carries a base station standard supported by the UE and location information of the UE, and the determination unit, for determining the set of candidate base stations of the UE according to the service request, is configured to determine the set of candidate base stations based on the base station standard supported by the UE and the location information of the UE, wherein a distance between a location of the UE and a location of any candidate base station in the set of candidate base stations is smaller than a predetermined distance.

16. The wireless controller according to claim 15, wherein,
the obtaining unit, for obtaining the channel quality information of the at least one candidate base station, is configured to:
send, by the sending unit, information about the at least one candidate base station to the UE, wherein the information about the at least one candidate base station comprises a base station identity (ID), a public land mobile network (PLMN), carrier information and a base station standard of the at least one candidate base station; and
receive, by the receiving unit, the channel quality information of the at least one candidate base station measured by the UE.

17. The wireless controller according to claim 15, wherein the obtaining unit, for obtaining the QoS policy corresponding to the service type of the UE, is configured to:
send, by the sending unit, a QoS policy query request to a policy and charging rules function (PCRF) entity of the UE, wherein the QoS policy query request is configured to request querying for a QoS policy of the UE in the PCRF and the QoS policy query request carries the service type of the UE; and
receive, by the receiving unit, information about the QoS policy corresponding to the service type of the UE sent by the PCRF.

18. The wireless controller according to claim 15, wherein the obtaining unit, for obtaining the resource usage information of the at least one candidate base station, is configured to:
send, by the sending unit, a resource block (RB) query message to a candidate base station of the at least one candidate base station, wherein the RB query message is configured to query for RB usage information of the candidate base station of the at least one candidate base station, and the RB usage information of the candidate base station is one of the resource usage information of the candidate base station; and
receive, by the receiving unit, the RB usage information sent by the candidate base station of the at least one candidate base station.

19. The wireless controller according to claim 15, wherein the obtaining unit, for obtaining the link information of the at least one transport network connected to the at least one candidate base station, is configured to:
send, by the sending unit, a link query message to a transport network controller of the at least one transport network connected to the at least one candidate base station, wherein the link query message is configured to query for the link information of the at least one transport network connected to the at least one candidate base station; and
receive, by the receiving unit, the link information of the at least one transport network connected to the at least one candidate base station sent by the transport network controller, wherein the link information comprises a transport network route delay and/or egress bandwidth usage information of the at least one transport network.

20. The wireless controller according to claim 15, wherein the obtaining unit, for obtaining the traffic control policy corresponding to the service type in the at least one transport network, is configured to:
send, by the sending unit, a traffic control policy query message to a transport network controller of the at least one transport network connected to the at least one candidate base station, wherein the traffic control policy query message is configured to query for the traffic control policy of the at least one transport network; and
receive, by the receiving unit, the traffic control policy of the at least one transport network sent by the transport network controller.

21. A user equipment, comprising:
a sending unit, configured to send a service request to a wireless network controller of the user equipment; and
a receiving unit, configured to receive a service acceptance message sent by the wireless controller according to the service request, wherein the service acceptance message carries information about a serving base station, the serving base station is a candidate base station determined by the wireless controller from a set of candidate base stations of the user equipment based on a predetermined rule, the set of candidate base stations of the user equipment comprises at least one candidate base station of the user equipment, and the set of candidate base stations of the user equipment is determined by the wireless controller according to the service request.

22. The user equipment according to claim 21, wherein,
the service request carries a service type of the user equipment; and
the wireless controller determining the serving base station based on the predetermined rule comprises the wireless controller determining the serving base station based on at least one of following information: a quality of service (QoS) policy corresponding to the service type, channel quality information of the at least one candidate base station, resource usage information of the at least one candidate base station, link information of at least one transport network connected to the at least one candidate base station and a traffic control policy corresponding to the service type in the at least one transport network.
